(19) United States
(12) Patent Application Publication
(10) Pub. No.: US 2026/0299633 A1
(43) Pub. Date: Oct. 1, 2026

(54) OPERATION INPUT DEVICE

(71) Applicant: AISIN CORPORATION, Kariya (JP)

(72) Inventors: Hiroshi ISONO, Kariya-shi (JP); Katsuhiro TSUJIMOTO, Kariya-shi (JP); Takeshi HASHIZUME, Kariya-shi (JP); Kosuke SUGIMACHI, Kariya-shi (JP)

(73) Assignee: AISIN CORPORATION, Kariya (JP)

(21) Appl. No.: 19/631,114

(22) Filed: Mar. 27, 2026

(30) Foreign Application Priority Data
Mar. 31, 2025 (JP) 2025-059460
Oct. 31, 2025 (JP) 2025-184599

(51) Int. Cl. G05G 5/03; B60K 26/02; B60T 7/04; G05G 1/38; G05G 5/05

(52) U.S. Cl. CPC G05G 5/03; G05G 5/05; B60K 26/021; B60T 7/042; G05G 1/38

(57) ABSTRACT

An operation input device includes an input member to which a rotational operation force is input, and a reaction force generation mechanism that generates a reaction force against the rotational operation force input to the input member, the reaction force generation mechanism includes a tubular member disposed on the reference axis, a piston accommodated in the tubular member, a linear motion conversion mechanism that mutually converts rotational motion of the input member and linear motion of the piston along the axial direction, a first elastic member that biases the piston toward the axial first side, and a second elastic member that biases the piston toward the axial first side and has a biasing force different from a biasing force of the first elastic member.

### CROSS REFERENCE TO RELATED APPLICATIONS

This application is based on and claims priority under 35 U.S.C. § 119 to Japanese Patent Application Nos. 2025-059460 and 2025-184599, filed on Mar. 31, 2025, and Oct. 31, 2025, the entire content of which is incorporated herein by reference.

### TECHNICAL FIELD

The present disclosure relates to an operation input device including an input member to which a rotational operation force is input and a reaction force generation mechanism that generates a reaction force against the rotational operation force input to the input member.

### BACKGROUND DISCUSSION

An example of such an operation input device is disclosed in JP 2008-143334 A. Hereinafter, in the background discussion, reference signs in the document are cited in parentheses.

In this operation input device, an input member (14) is coupled to an operation tool (80) operated by a driver of a vehicle so as to rotate integrally with the operation tool. A reaction force generation mechanism includes a tubular member (18A) disposed on a reference axis (12), a piston (16) accommodated in the tubular member (18A), and a linear motion conversion mechanism that mutually converts rotational motion of the input member (14) and linear motion of the piston (16) along the reference axis (12).

In the above operation input device, the piston (16) is biased by an elastic member (68) in a direction opposite to a moving direction of the piston (16) in a case where the operation tool (80) is operated by the driver. A space between an outer peripheral surface of the piston (16) and an inner peripheral surface of the tubular member (18A) is sealed by seal members (64 and 66).

Therefore, in the above reaction force generation mechanism, in a case where the operation tool (80) is operated by the driver, a reaction force against the rotational operation force input to the input member is generated on the basis of a biasing force of the elastic member (68) and a frictional force of the seal members (64 and 66).

However, in the configuration as described above, in a case where the frictional force of the seal members (64 and 66) is increased in order to improve a feeling of operation, there is a possibility that a return operation of the input member (14) to an initial position in a case where an operation of the operation tool (80) by the driver is released becomes difficult. In the operation input device described above, if the reaction force characteristic with respect to the intended stroke with respect to the operation tool is implemented only by changing the linear motion conversion ratio, for example, in a case where an operation target is a braking device, it is necessary to set the linear motion conversion ratio at an initial stage of the stroke to be high, for example, about three to four times a normal linear motion conversion ratio in order to exert a braking force that is easy for an occupant to perceive. However, if the linear motion conversion ratio at the initial stage of stroke is increased, it is also necessary to set a large frictional force necessary for holding the operation tool (80). On the other hand, from the middle stage to the late stage of stroke, it is necessary to lower the linear motion conversion ratio than in the initial stage in order to achieve both ease of returning of the operation tool (80) and comfortable feeling of operation (for example, stepping comfort). Therefore, hysteresis on an operation surface (on a pedal surface) increases as compared with an early stroke, and there is a possibility that the return operation from the middle to the late stroke becomes difficult. In a case where the frictional force is set to be small in order to optimize the return operation from the middle stage to the late stage of the stroke, the hysteresis on the operation surface at the early stage of the stroke becomes extremely low to about one third to one fourth, and there is a possibility that it becomes difficult to hold the operation tool in the region of the early stage of the stroke.

In the above reaction force generation mechanism, the biasing force by the elastic member (68) and the frictional force by the seal members (64 and 66) are used as the reaction force against the rotational operation force, but there is still room for improvement in improvement of the feeling of operation (operation feeling) when the driver operates the operation tool (80). For example, the feeling of operation of the operation tool includes factors such as good response when the driver operates the operation tool, balance between stiffness and response, reaction at the time of sudden operation, holding of the operation tool, and ease of returning of the operation tool. There is still room for improvement in appropriately satisfying these elements.

A need thus exists for an operation input device which is not susceptible to the drawback mentioned above.

### SUMMARY

An operation input device includes an input member to which a rotational operation force is input, and a reaction force generation mechanism that generates a reaction force against the rotational operation force input to the input member, in which a direction along a reference axis is defined as an axial direction, one side in the axial direction is defined as an axial first side, and another side in the axial direction is defined as an axial second side, the reaction force generation mechanism includes a tubular member disposed on the reference axis, a piston accommodated in the tubular member, a linear motion conversion mechanism that mutually converts rotational motion of the input member and linear motion of the piston along the axial direction, a first elastic member that biases the piston toward the axial first side, and a second elastic member that biases the piston toward the axial first side and has a biasing force different from a biasing force of the first elastic member, a region in which the first elastic member is mainly deformed when the piston moves to the axial second side with respect to the tubular member along the axial direction is defined as a first stroke region, and a region in which the second elastic member is mainly deformed is defined as a second stroke region, a movement amount of the piston with respect to a rotation angle of the input member is defined as a linear motion conversion ratio of the linear motion conversion mechanism, a value obtained by dividing a difference between the linear motion conversion ratio of a first start that is a start of the first stroke region and the linear motion conversion ratio of a first end that is an end of the first stroke region by the linear motion conversion ratio of the first start is set as a first variable rate, a value obtained by dividing a difference between the linear motion conversion ratio of a second start that is a start of the second stroke region and the linear motion conversion ratio of a second end that is an end of the second stroke region by the linear motion conversion ratio of the second start is defined as a second variable rate, and the linear motion conversion mechanism is configured such that the second variable rate is higher than the first variable rate.

An operation input device includes
an input member to which a rotational operation force is input, and
a reaction force generation mechanism that generates a reaction force against the rotational operation force input to the input member, in which
a direction along a reference axis is defined as an axial direction, one side in the axial direction is defined as an axial first side, and another side in the axial direction is defined as an axial second side,
the reaction force generation mechanism includes
a tubular member disposed on the reference axis,
a piston accommodated in the tubular member,
a linear motion conversion mechanism that mutually converts rotational motion of the input member and linear motion of the piston along the axial direction,
a first elastic member that biases the piston toward the axial first side, and
a second elastic member that biases the piston toward the axial first side and has a biasing force different from a biasing force of the first elastic member,
a direction orthogonal to the reference axis is defined as a radial direction, a direction toward the reference axis along the radial direction is defined as a radial inside, and a direction away from the reference axis along the radial direction is defined as a radial outside,
the reaction force generation mechanism includes
a friction member disposed at a sliding portion between an outer peripheral surface of the piston and an inner peripheral surface of the tubular member, and
a strained force application mechanism that presses the friction member from the radial inside toward the radial outside and applies a strained force to an inner peripheral surface of the tubular member, or presses the friction member from the radial outside toward the radial inside and applies a strained force to an outer peripheral surface of the piston,
the friction member includes
a sliding member disposed on a sliding surface between the tubular member and the piston, and
a base material to which the sliding member is bonded on the radial outside or the radial inside, and
the strained force application mechanism presses the base material on which the sliding member is disposed on the radial outside from the radial inside toward the radial outside, or presses the base material on which the sliding member is disposed on the radial inside from the radial outside toward the radial inside.

An operation input device includes an input member to which a rotational operation force is input, and a reaction force generation mechanism that generates a reaction force against the rotational operation force input to the input member, in which a direction along a reference axis is defined as an axial direction, one side in the axial direction is defined as an axial first side, and another side in the axial direction is defined as an axial second side, the reaction force generation mechanism includes
a tubular member disposed on the reference axis, a piston accommodated in the tubular member, a linear motion conversion mechanism configured to mutually convert rotational motion of the input member and linear motion of the piston along the axial direction, an elastic member that biases the piston toward the axial first side, and a friction member disposed at a sliding portion between an outer peripheral surface of the piston and an inner peripheral surface of the tubular member, and the friction member is configured to have a larger frictional force in a case where the piston moves to the axial second side than in a case where the piston moves to the axial first side.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of an operation input device according to a first embodiment;

FIG. 2 is a sectional view along an axial direction of the operation input device according to the first embodiment;

FIG. 3 is a sectional view along a radial direction of the operation input device according to the first embodiment;

FIG. 4 is a diagram showing a configuration of a piston of the operation input device according to the first embodiment;

FIG. 5 is a sectional view along an axial direction of the operation input device according to a second embodiment;

FIG. 6 is a sectional view along an axial direction of an operation input device according to a third embodiment;

FIG. 7 is a diagram showing a configuration of a linear motion conversion mechanism of the operation input device according to the third embodiment;

FIG. 8 is a graph showing a relationship between an operation force (pedal force) on an input member 1 and a movement amount (pedal stroke) of the input member;

FIG. 9 is a side view of an operation input device according to fourth to seventh embodiments;

FIG. 10 is a sectional view along an axial direction of the operation input device according to the fourth embodiment;

FIG. 11 is a sectional view along an axial direction of the operation input device according to the fifth embodiment;

FIG. 12 is a sectional view along an axial direction of the operation input device according to the sixth embodiment;

FIG. 13 is a sectional view along an axial direction of the operation input device according to the seventh embodiment;

FIG. 14 is a side view of an operation input device according to an eighth embodiment;

FIG. 15 is a graph showing a rotation linear motion conversion ratio of the operation input device according to the eighth embodiment;

FIG. 16 is a sectional view along an axial direction of an operation input device according to a ninth embodiment;

FIG. 17 is a sectional view along a radial direction of the operation input device according to the ninth embodiment;

FIG. 18 is a diagram showing configurations of a cam mechanism and a guide mechanism of the operation input device according to the ninth embodiment; and

FIG. 19 is a graph showing a rotation linear motion conversion ratio of the operation input device according to the ninth embodiment.

### DETAILED DESCRIPTION

### First Embodiment

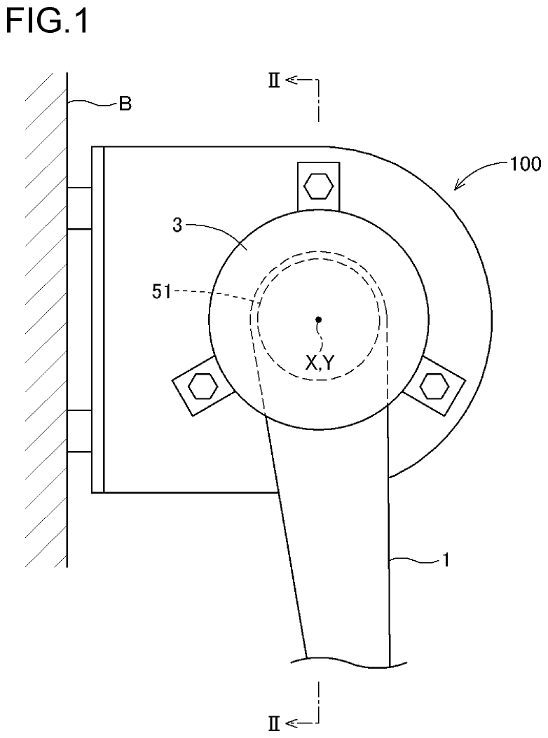

First, an operation input device 100 according to a first embodiment will be described with reference to FIGS. 1 to 4. As shown in FIG. 1, in the present embodiment, the operation input device 100 is fixed to a vehicle body B of a vehicle.

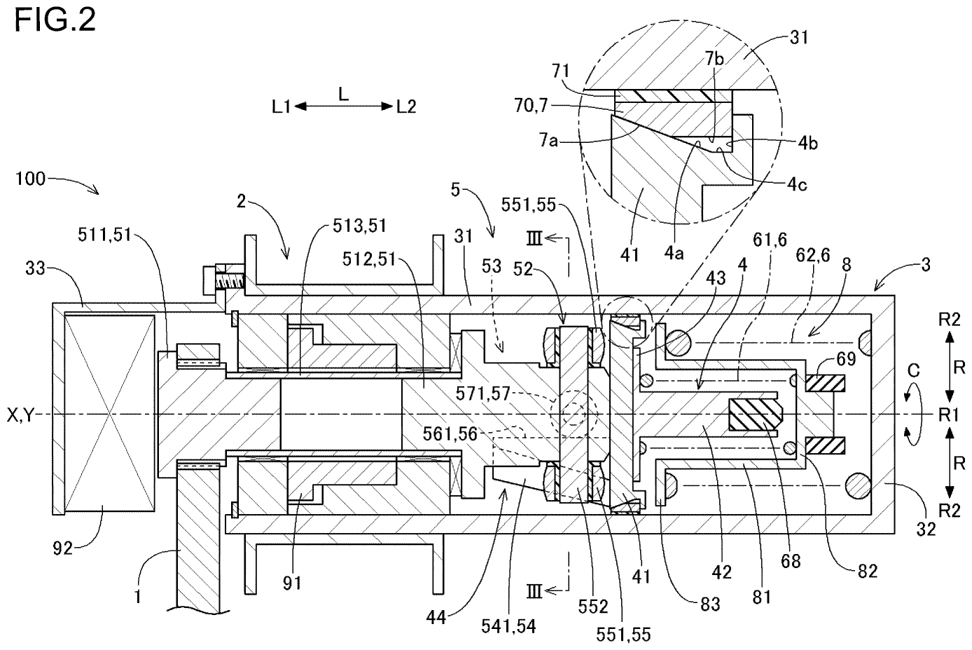

As shown in FIG. 2, the operation input device 100 includes an input member 1 and a reaction force generation mechanism 2.

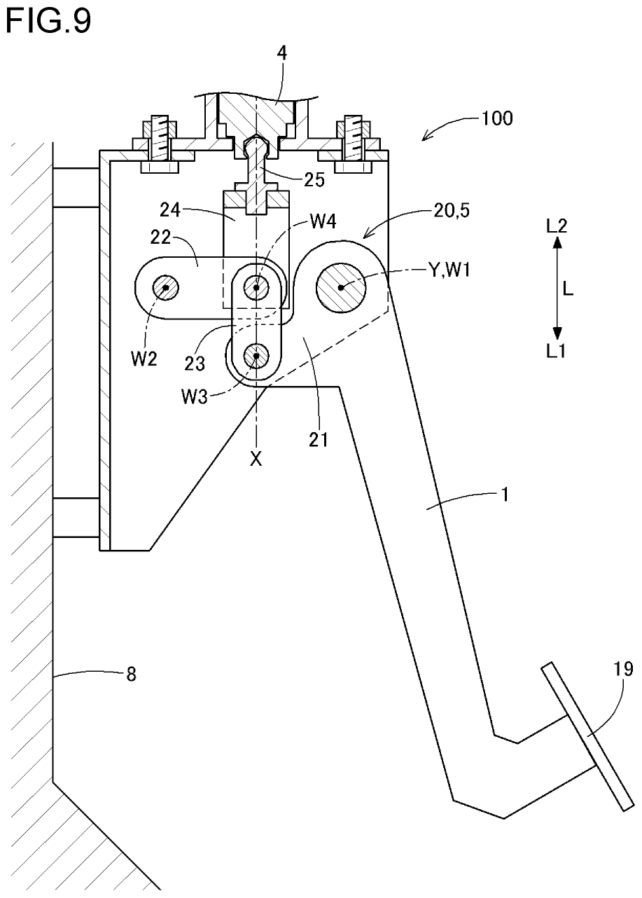

The input member 1 is a member to which a rotational operation force is input. The input member 1 is coupled to an operation tool (pedal 19: omitted in FIG. 1, see FIG. 9) operated by a driver of the vehicle. In the present embodiment, the input member 1 is an arm member that swings about a swing axis Y (which coincides with a reference axis X described later in the first embodiment). In the present embodiment, the operation tool coupled to the input member 1 is an accelerator pedal or a brake pedal. Note that the input member 1 may be coupled so as to swing integrally with the operation tool. Alternatively, the input member 1 may be coupled to the operation tool via a gear mechanism, a link mechanism, or the like. In such a configuration, the swing axis Y of the input member 1 may be disposed on an axis different from the reference axis X.

As will be described later, a moving direction of a linear motion in a rotation linear motion conversion mechanism (linear motion conversion mechanism 5) that is provided in the reaction force generation mechanism 2 and mutually converts a rotational motion and a linear motion is a direction along the “reference axis X”. In the first embodiment, the “reference axis X” is also a rotational axis of the rotational motion. In the following description, a direction along the reference axis X is referred to as an “axial direction L”. Then, one side in the axial direction L is referred to as an “axial first side L1”, and the other side in the axial direction L is referred to as an “axial second side L2”. A direction orthogonal to a certain axis (for example, the reference axis X) is defined as a “radial direction R” with reference to the axis, and a direction around the certain axis (for example, reference axis X) is defined as a “circumferential direction C” with reference to the axis. A direction toward the axis (for example, the reference axis X) along the radial direction R is defined as a radial inside R1, and a direction away from the axis (for example, the reference axis X) along the radial direction R is defined as a radial outside R2.

The reaction force generation mechanism 2 is configured to generate a reaction force against the rotational operation force input to the input member 1. The reaction force generated by the reaction force generation mechanism 2 causes the driver to perceive an operation amount of the pedal 19. In the present embodiment, the reaction force generation mechanism 2 generates a reaction force that returns the pedal 19 to an initial position when the driver steps on the pedal 19 which is an accelerator pedal or a brake pedal.

The reaction force generation mechanism 2 includes a tubular member 3, a piston 4, a linear motion conversion mechanism 5, an elastic member 6, and a friction member 7. In the present embodiment, the reaction force generation mechanism 2 further includes a holding member 8.

The tubular member 3 has a tubular shape. The tubular member 3 is disposed on the reference axis X. That is, the tubular member 3 has a tubular shape centered on the reference axis X. In the present embodiment, the tubular member 3 is a housing that accommodates the piston 4, the linear motion conversion mechanism 5, the elastic member 6, and the friction member 7. Then, the tubular member 3 includes a peripheral wall 31 and a bottom wall 32.

The peripheral wall 31 is open to the axial first side L1 and the axial second side L2, and has a cylindrical shape centered on the reference axis X.

The bottom wall 32 is disposed so as to close the opening on the axial second side L2 of the peripheral wall 31. In the present embodiment, the bottom wall 32 is formed integrally with the peripheral wall 31.

The piston 4 is accommodated in the tubular member 3. The piston 4 is configured to be movable along the axial direction L. In the present embodiment, the piston 4 includes a slider 41, a shaft 42, and a flange 43.

The slider 41 is configured to slide in the axial direction L on an inner peripheral surface of the peripheral wall 31. In the present embodiment, the slider 41 has a disk shape centered on the reference axis X.

The shaft 42 is formed to extend along the axial direction L. The shaft 42 is disposed on the reference axis X. In the present embodiment, the shaft 42 is formed to extend from the flange 43 toward the axial second side L2.

The flange 43 is formed to extend from the shaft 42 toward the radial outside R2. In the present embodiment, the flange 43 is joined to the slider 41 from the axial second side L2.

The linear motion conversion mechanism 5 is configured to mutually convert the rotational motion of the input member 1 and the linear motion of the piston 4 along the axial direction L. In the present embodiment, the linear motion conversion mechanism 5 includes a transmission member 51, a cam mechanism 52, and a guide mechanism 53.

The transmission member 51 is a shaft member to which rotation of the input member 1 is transmitted. The transmission member 51 is disposed on the reference axis X. The transmission member 51 is supported so as to be rotatable about the reference axis X with respect to the tubular member 3. In the present embodiment, the transmission member 51 includes a first coupling portion 511, a second coupling portion 512, and a third coupling portion 513.

The first coupling portion 511 is coupled so as to rotate integrally with the input member 1. The second coupling portion 512 is disposed away from the first coupling portion 511 on the axial second side L2. The second coupling portion 512 is coupled to the cam mechanism 52. The third coupling portion 513 is formed to couple the first coupling portion 511 and the second coupling portion 512 in the axial direction L. The third coupling portion 513 has a cylindrical shape centered on the reference axis X.

The cam mechanism 52 is configured to mutually convert the rotational motion of the transmission member 51 and the linear motion of the piston 4 along the axial direction L.

The guide mechanism 53 is configured to restrict a relative rotation of the piston 4 in the circumferential direction C with respect to the tubular member 3 and allow a relative movement of the piston 4 in the axial direction L with respect to the tubular member 3.

The elastic member 6 is a member that biases the piston 4 toward the axial first side L1. In the present embodiment, the elastic member 6 includes an inner spring 61 (first elastic member) and an outer spring 62 (second elastic member). In the present embodiment, each of the inner spring 61 and the outer spring 62 is a compression coil spring.

The holding member 8 is a member for holding the elastic member 6. In the present embodiment, the holding member 8 includes a cylinder 81, an inner holder 82, and an outer holder 83.

The cylinder 81 has a bottomed cylindrical shape centered on the reference axis X with the axial first side L1 opened and the axial second side L2 closed. The cylinder 81 is disposed so as to cover the shaft 42 of the piston 4 from the radial outside R2.

The inner holder 82 has a disk shape centered on the reference axis X. The inner holder 82 closes the axial second side L2 of the cylinder 81.

The outer holder 83 has an annular plate shape centered on the reference axis X. The outer holder 83 is formed so as to protrude toward the radial outside R2 from an end of the cylinder 81 on the axial first side L1.

The inner spring 61 is disposed between the flange 43 of the piston 4 and the inner holder 82 of the holding member 8 in the axial direction L in a state where the shaft 42 of the piston 4 is inserted. The outer spring 62 is disposed between the outer holder 83 of the holding member 8 and the bottom wall 32 of the tubular member 3 in the axial direction L in a state where the cylinder 81 of the holding member 8 is inserted.

The friction member 7 is disposed at a sliding portion between an outer peripheral surface of the piston 4 and an inner peripheral surface of the tubular member 3. In the present embodiment, the friction member 7 is disposed between the outer peripheral surface of the slider 41 of the piston 4 and the inner peripheral surface of the peripheral wall 31 of the tubular member 3.

In the present embodiment, the friction member 7 is attached to the outer peripheral surface of the piston 4. Then, the friction member 7 is disposed in a state of being pressed against the inner peripheral surface of the tubular member 3. In the present embodiment, the friction member 7 is an annular elastic body. Then, the friction member 7 is disposed on the reference axis in a state of being attached to the outer peripheral surface of the piston 4. In this example, the friction member 7 is configured by synthetic resin.

In the present embodiment, the outer peripheral surface of the piston 4 includes an outer peripheral inclined surface 4a, an outer peripheral restriction surface 4b, and an outer peripheral parallel surface 4c.

The outer peripheral inclined surface 4a is inclined to the radial outside R2 toward the axial first side L1. In the present embodiment, the outer peripheral inclined surface 4a is formed from an end of the slider 41 on the axial first side L1.

The outer peripheral restriction surface 4b is formed to restrict movement of the friction member 7 toward the axial second side L2. The outer peripheral restriction surface 4b is formed to extend along the radial direction R. The outer peripheral restriction surface 4b is disposed away from the outer peripheral inclined surface 4a toward the axial second side L2.

The outer peripheral parallel surface 4c is formed so as to be parallel to the axial direction L. The outer peripheral parallel surface 4c is disposed between the outer peripheral inclined surface 4a and the outer peripheral restriction surface 4b in the axial direction L.

In the present embodiment, an inner peripheral surface of the friction member 7 includes an inner peripheral inclined surface 7a and an inner peripheral parallel surface 7b.

The inner peripheral inclined surface 7a is formed along the outer peripheral inclined surface 4a. That is, the inner peripheral inclined surface 7a is inclined to the radial outside R2 toward the axial first side L1. The inner peripheral inclined surface 7a is disposed so as to be in contact with the outer peripheral inclined surface 4a.

The inner peripheral parallel surface 7b is formed so as to be parallel to the axial direction L. In the present embodiment, the inner peripheral parallel surface 7b is formed so as to be continuous with the inner peripheral inclined surface 7a from the end of the friction member 7 on the axial second side L2.

In the present embodiment, in a case where the piston 4 moves to the axial first side L1, the friction member 7 moves to the axial first side L1 together with the piston 4 because the movement of the friction member 7 to the axial second side L2 is restricted by the outer peripheral restriction surface 4b.

On the other hand, in a case where the piston 4 moves to the axial second side L2, the friction member 7 moves relative to the piston 4 to the axial first side L1 so that the inner peripheral inclined surface 7a slides on the outer peripheral inclined surface 4a. At this time, a width in the radial direction R between the outer peripheral inclined surface 4a of the piston 4 and the inner peripheral surface of the tubular member 3 gradually decreases toward the axial first side L1. Therefore, as the piston 4 moves to the axial second side L2 and the friction member 7 moves relative to the piston 4 to the axial first side L1, a frictional force acting on the friction member 7 increases.

In this manner, the friction member 7 is configured such that the frictional force is larger in a case where the piston 4 moves to the axial second side L2 than in a case where the piston 4 moves to the axial first side L1.

In the present embodiment, a viscoelastic body 71 is disposed on a sliding surface of the friction member 7. The viscoelastic body 71 is a member having viscoelasticity. In the present embodiment, the viscoelastic body 71 is attached to the outer peripheral surface of the friction member 7. In the present embodiment, the viscoelastic body 71 is a so-called semi-dry friction material impregnated with oil. In this example, the viscoelastic body 71 is a fibrous material impregnated with high-viscosity grease.

As shown in FIG. 2, in the present embodiment, the operation input device 100 further includes a first operation amount sensor 91 and a second operation amount sensor 92.

The first operation amount sensor 91 is a sensor for detecting an operation amount of the input member 1. The first operation amount sensor 91 is configured to detect at least one of a rotation amount or a twist of the third coupling portion 513 of the transmission member 51. The first operation amount sensor 91 is, for example, a rotation sensor that detects a rotation amount of the third coupling portion 513, a torque sensor that detects the twist of the third coupling portion 513, or the like. The first operation amount sensor 91 is accommodated on the radial inside R1 with respect to the tubular member 3. In the present embodiment, the first operation amount sensor 91 is disposed on the radial inside R1 with respect to the peripheral wall 31 of the tubular member 3.

The second operation amount sensor 92 is a sensor for detecting an operation amount of the input member 1. In the present embodiment, the second operation amount sensor 92 is disposed to be adjacent to the first coupling portion 511 on the axial first side L1 of the transmission member 51. Then, the second operation amount sensor 92 is a rotation sensor that detects the rotation amount of the first coupling portion 511. In the present embodiment, the second operation amount sensor 92 is fixed to a cover 33. The cover 33 is formed so as to cover a part of the input member 1 in the circumferential direction C from the radial outside R2 and cover a part of the input member 1 in the radial direction R from the axial first side L1. The cover 33 is joined to the peripheral wall 31 of the tubular member 3 from the axial first side L1.

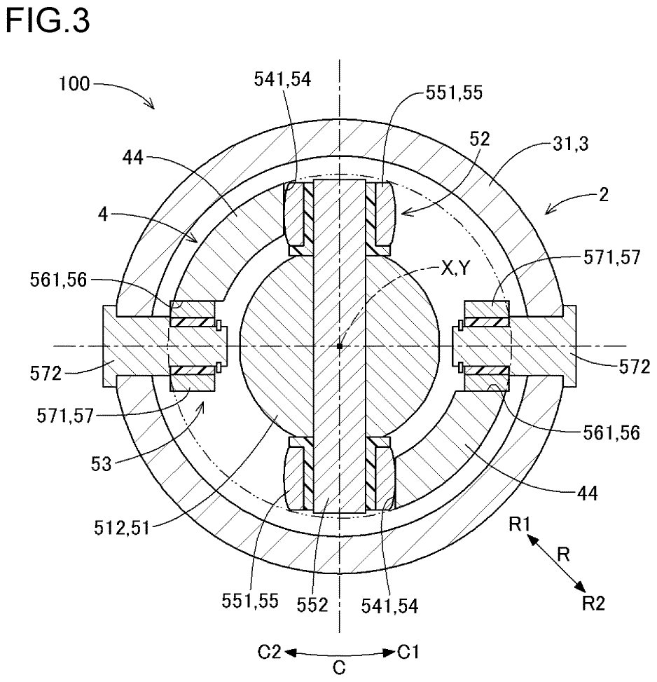

As shown in FIGS. 2 and 3, in the present embodiment, the cam mechanism 52 includes a cam path 54 and a cam follower member 55. The cam path 54 extends along a direction inclined with respect to both the axial direction L and the circumferential direction C. The cam follower member 55 is configured to move along the cam path 54. One of the cam path 54 or the cam follower member 55 is provided in the transmission member 51. The other one of the cam path 54 or the cam follower member 55 is provided in the piston 4. In the present embodiment, the cam path 54 is provided in the piston 4, and the cam follower member 55 is provided in the transmission member 51.

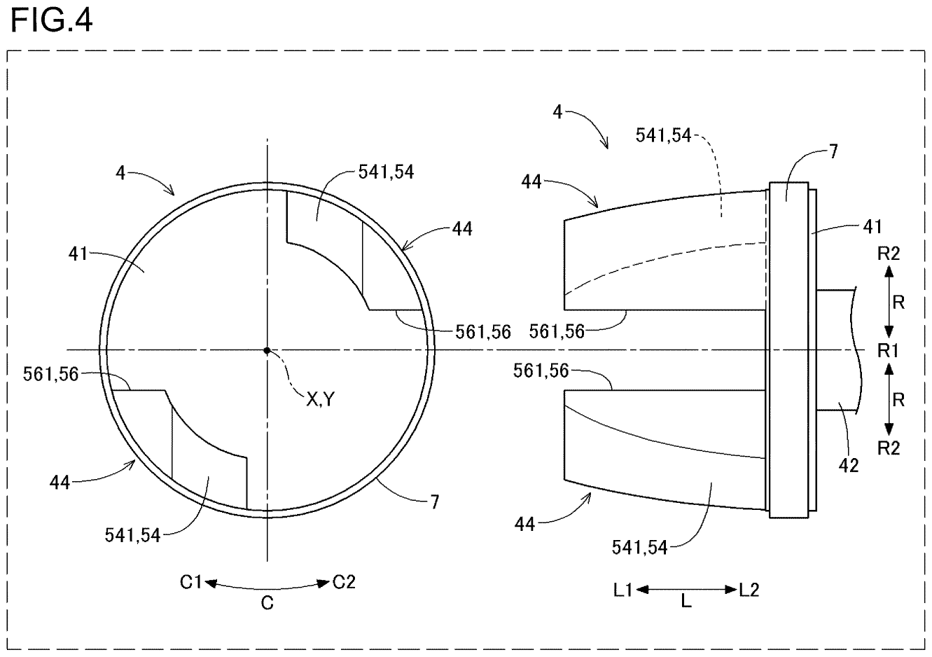

As shown in FIG. 4, in the present embodiment, the piston 4 includes a pair of path forming portions 44. The pair of path forming portions 44 is formed so as to protrude from the slider 41 toward the axial first side L1. In the present embodiment, the pair of path forming portions 44 is disposed so as to be point-symmetric about the reference axis X as viewed in the axial direction along the axial direction L. In the example shown in the drawing, each of the pair of path forming portions 44 has an arc shape in which a central angle about the reference axis X is smaller than 45 degrees as viewed in the axial direction along the axial direction L.

In the following description, one side in the circumferential direction C is referred to as a “circumferential first side C1”, and the other side in the circumferential direction C is referred to as a “circumferential second side C2”.

In the present embodiment, the cam path 54 is a cam surface 541 formed in each of the pair of path forming portions 44. That is, in the present embodiment, the plurality of (here, two) cam paths 54 is disposed at equal intervals in the circumferential direction C. In the example shown in FIG. 4, each of the pair of cam surfaces 541 has an arc shape centered on the reference axis X as viewed in the axial direction along the axial direction L. Then, each of the pair of cam surfaces 541 is gradually inclined to the axial first side L1 toward the circumferential first side C1.

As shown in FIGS. 2 and 3, in the present embodiment, the cam follower member 55 is a cam roller 551. In the present embodiment, the cam roller 551 rolls on each of the pair of cam surfaces 541. That is, in the present embodiment, one cam follower member 55 is provided for one cam path 54 so that the pair of cam rollers 551 corresponds to the pair of cam surfaces 541. In this manner, in the present embodiment, the cam mechanism 52 includes a plurality of (here, two) sets of the cam path 54 and the cam follower member 55.

In the present embodiment, a coupling shaft 552 formed to extend along the radial direction R is fixed to the second coupling portion 512 in a state of penetrating the second coupling portion 512 of the transmission member 51 in the radial direction R. Then, the cam roller 551 is rotatably supported by each portion of the coupling shaft 552 protruding from the second coupling portion 512 toward both sides in the radial direction R. Therefore, in the present embodiment, each of the pair of cam rollers 551 is configured to rotate about an axis of the coupling shaft 552 and rotate (revolve) about the reference axis X along with the rotation of the coupling shaft 552.

In the present embodiment, each of the pair of cam rollers 551 is disposed so as to abut on the cam surface 541 from the circumferential second side C2. Then, each of the pair of cam rollers 551 is disposed so as to be located closest to the axial second side L2 on the cam surface 541 in a state where the rotational operation force is not input to the input member 1.

In the present embodiment, each of the pair of cam rollers 551 is a so-called spherical outer-ring-shaped cam follower having an outer peripheral surface in which an outer edge in an axial view along the axial direction L has an arc shape (see FIG. 3). Such a configuration enables the cam roller 551 to appropriately roll on the cam surface 541 while rotating in the circumferential direction C.

In the present embodiment, the guide mechanism 53 includes a guide path 56 and a guide follower member 57.

The guide path 56 extends along the axial direction L. The guide follower member 57 is configured to move along the guide path 56. One of the guide path 56 or the guide follower member 57 is provided in the piston 4. The other one of the guide path 56 or the guide follower member 57 is provided in the tubular member 3. In the present embodiment, the guide path 56 is provided in the piston 4, and the guide follower member 57 is provided in the tubular member 3.

In the present embodiment, the arrangement regions of the cam path 54 and the guide path 56 in the axial direction L overlap each other. The arrangement regions of the cam follower member 55 and the guide follower member 57 in the axial direction L overlap each other.

As shown in FIG. 4, in the present embodiment, the guide path 56 is a guide surface 561 formed in each of the pair of path forming portions 44. That is, in the present embodiment, the plurality of (here, two) guide paths 56 is disposed at equal intervals in the circumferential direction C. In the example shown in FIG. 4, each of the pair of guide surfaces 561 is formed to face the circumferential first side C1. Then, each of the pair of guide surfaces 561 is formed linearly along the axial direction L as viewed in the radial direction along the radial direction R.

As shown in FIGS. 2 and 3, in the present embodiment, the guide follower member 57 is a guide roller 571 that rolls on each of the pair of guide surfaces 561. That is, in the present embodiment, one guide follower member 57 is provided for one guide path 56 so that the pair of guide rollers 571 corresponds to the pair of guide surfaces 561. In this manner, in the present embodiment, the guide mechanism 53 includes a plurality of (here, two) sets of the guide path 56 and the guide follower member 57.

As shown in FIG. 3, in the present embodiment, each of the pair of guide rollers 571 is disposed so as to abut on the guide surface 561 from the circumferential first side C1. Then, as shown in FIG. 2, each of the pair of guide rollers 571 is disposed so as to be located closest to the axial second side L2 on the guide surface 561 in a state where the rotational operation force is not input to the input member 1.

As shown in FIG. 3, in the present embodiment, each of the pair of guide rollers 571 is rotatably supported with respect to a support shaft 572 formed to extend along the radial direction R. The pair of support shafts 572 is disposed on both sides in the radial direction R with respect to the reference axis X. The pair of support shafts 572 is fixed to the peripheral wall 31 of the tubular member 3.

In the present embodiment, when the rotational operation force is input to the input member 1 and the transmission member 51 rotates, the pair of cam rollers 551 rotates (revolves) to the circumferential first side C1 about the reference axis X via the coupling shaft 552 coupled to the second coupling portion 512 of the transmission member 51. Accordingly, each of the pair of cam rollers 551 rolls on the cam surface 541 in a state of being in contact with the cam surface 541 from the circumferential second side C2. At this time, each of the pair of guide rollers 571 rolls on the guide surface 561 in a state of being in contact with the guide surface 561 from the circumferential first side C1. Therefore, in a state where the rotation of the piston 4 in the circumferential direction C with respect to the tubular member 3 is restricted, the piston 4 moves to the axial second side L2 with respect to the tubular member 3 against the reaction force generated by the reaction force generation mechanism 2.

On the other hand, in a case where the rotational operation force is not input to the input member 1, the reaction force generated by the reaction force generation mechanism 2 presses the piston 4 toward the axial first side L1. Accordingly, each of the pair of cam rollers 551 rolls on the cam surface 541 in a state of being in contact with the cam surface 541 from the circumferential second side C2. At this time, each of the pair of guide rollers 571 rolls on the guide surface 561 in a state of being in contact with the guide surface 561 from the circumferential first side C1. Therefore, in a state where the rotation of the piston 4 in the circumferential direction C with respect to the tubular member 3 is restricted, the pair of cam rollers 551 rotates (revolves) to the circumferential second side C2 about the reference axis X, and the input member 1 rotates so as to return to an initial position via the transmission member 51.

### 2. Second Embodiment

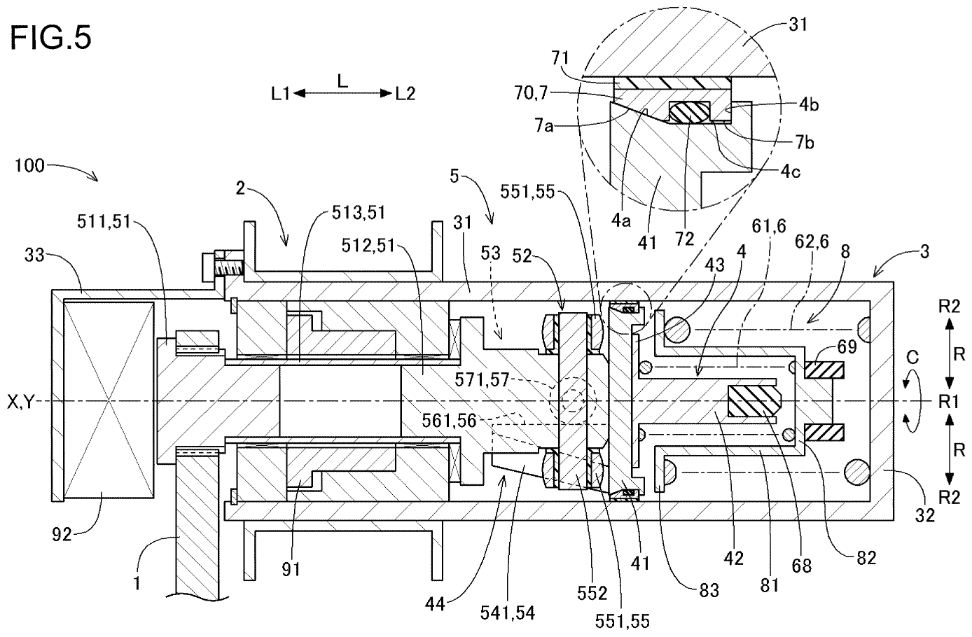

Hereinafter, an operation input device 100 according to a second embodiment will be described with reference to FIG. 5. In the present embodiment, the configuration of the friction member 7 is different from that of the first embodiment. Hereinafter, differences from the first embodiment will be mainly described. Note that points not specifically described are similar to those in the first embodiment.

As shown in FIG. 5, in the present embodiment, an elastic body 72 is disposed on the inner peripheral surface of the friction member 7. The elastic body 72 has an annular shape. The elastic body 72 is disposed so as to seal between the inner peripheral surface of the friction member 7 and the outer peripheral surface of the slider 41 of the piston 4. In the example shown in the drawing, a groove is formed in the friction member 7 such that the inner peripheral parallel surface 7b is recessed toward the radial outside R2 over an entire circumference in the circumferential direction C. Then, the elastic body 72 is disposed in the groove so as to be in contact with the outer peripheral parallel surface 4c of the piston 4. Note that in this example, the elastic body 72 is an O-ring.

In such a configuration, the frictional force when the friction member 7 moves relative to the piston 4 on the axial first side L1 is larger than in the first embodiment.

### 3. Third embodiment

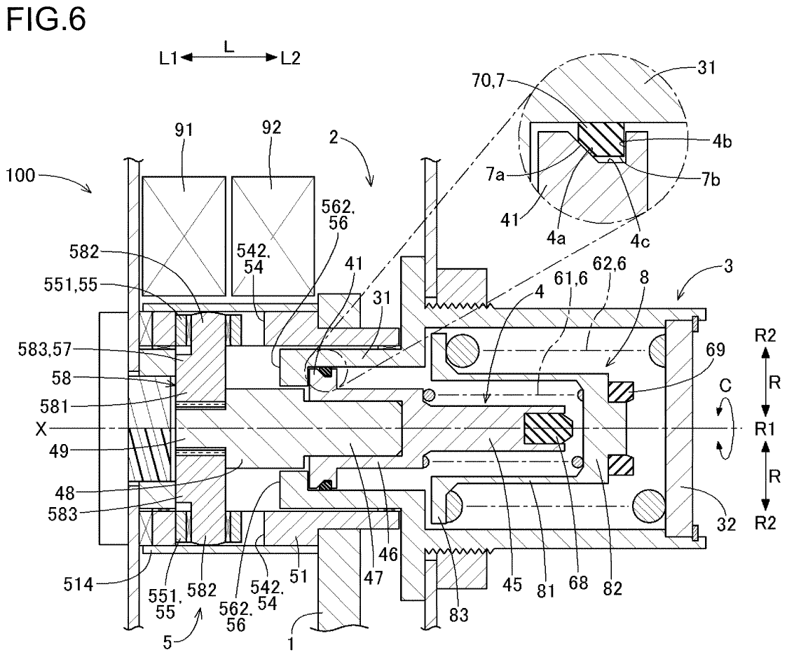

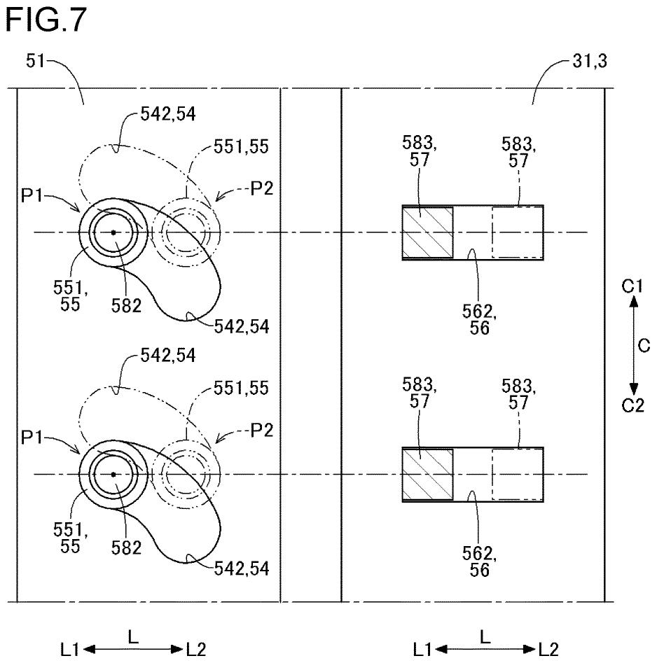

First, an operation input device 100 according to a third embodiment will be described with reference to FIGS. 6 and 7. In the present embodiment, the configuration of the reaction force generation mechanism 2 is different from that of the first embodiment. Hereinafter, differences from the first embodiment will be mainly described. Note that points not specifically described are similar to those in the first embodiment.

As shown in FIG. 6, in the present embodiment, the piston 4 includes a distal end 45, a holder 46, a small diameter portion 47, a large diameter portion 48, and a coupling portion 49.

The distal end 45 is formed to extend from the holder 46 toward the axial second side L2. The distal end 45 is formed to have a smaller diameter than the holder 46. The holder 46 has a cylindrical shape centered on the reference axis X. The holder 46 is formed integrally with the distal end 45. In the present embodiment, the inner spring 61 is disposed between the holder 46 and the inner holder 82 in the axial direction L in a state where the distal end 45 is inserted.

In the present embodiment, the slider 41 is formed so as to protrude toward the radial outside R2 from an end of the holder 46 on the axial first side L1.

In the present embodiment, the friction member 7 is configured by synthetic rubber. In the present embodiment, the viscoelastic body 71 is not disposed on the sliding surface of the friction member 7. Therefore, in the present embodiment, the outer peripheral surface of the friction member 7 and the inner peripheral surface of the peripheral wall 31 are in direct contact with each other.

The small diameter portion 47 is disposed on the radial inside R1 with respect to the holder 46. The small diameter portion 47 abuts on the distal end 45 from the axial first side L1 and is restricted from moving on the axial second side L2.

The large diameter portion 48 is formed to have a larger diameter than the small diameter portion 47. The large diameter portion 48 is disposed on the axial first side L1 with respect to the small diameter portion 47. The large diameter portion 48 is formed integrally with the small diameter portion 47.

The coupling portion 49 is formed so as to protrude from the large diameter portion 48 toward the axial first side L1. The coupling portion 49 is formed to have a smaller diameter than the large diameter portion 48. The coupling portion 49 is formed integrally with the large diameter portion 48.

In the present embodiment, the transmission member 51 has a cylindrical shape centered on the reference axis X. The transmission member 51 is disposed on the radial outside R2 with respect to the peripheral wall 31 of the tubular member 3. The transmission member 51 is rotatably supported by the peripheral wall 31.

In the present embodiment, the cam path 54 is a cam groove 542 formed in the transmission member 51. The cam groove 542 is formed so as to extend along a direction inclined with respect to both the axial direction L and the circumferential direction C (see FIG. 7). In the present embodiment, the cam roller 551 rolls on an inner surface of the cam groove 542. In the present embodiment, a plurality of cam grooves 542 is dispersedly disposed in the circumferential direction C.

In the present embodiment, the tubular cover member 515 is coupled to the transmission member 51 from the radial outside R2 so as to cover all the cam grooves 542. In the present embodiment, the first operation amount sensor 91 and the second operation amount sensor 92 are disposed on the radial outside R2 with respect to the cover member 515 and on the axial first side L1 with respect to the input member 1.

In the present embodiment, the guide path 56 is a guide groove 562 formed in the tubular member 3. The guide groove 562 is a long hole-shaped groove extending along the axial direction L. The guide groove 562 is formed so as to penetrate the peripheral wall 31 of the tubular member 3 in the radial direction R. In the present embodiment, a plurality of guide grooves 562 is dispersedly disposed in the circumferential direction C.

In the present embodiment, the linear motion conversion mechanism 5 includes a coupling member 58. The coupling member 58 is a member that couples the cam follower member 55 and the piston 4. The coupling member 58 includes a connector 581, a support 582, and a guided portion 583.

The connector 581 is connected to the coupling portion 49 of the piston 4. In the present embodiment, the connector 581 has a tubular shape covering the coupling portion 49 from the radial outside R2. A plurality of splines extending in the axial direction L are dispersedly formed in the circumferential direction C on an inner peripheral portion of the connector 581. On the other hand, on an outer peripheral portion of the coupling portion 49, a plurality of splines to be engaged therewith are dispersedly formed in the circumferential direction C.

Thus, in the present embodiment, the connector 581 is supported movably in the axial direction L with respect to the piston 4 in a state where the rotation in the circumferential direction C is restricted. As described above, in the present embodiment, the coupling portion 49 is formed to have a smaller diameter than the large diameter portion 48. Therefore, the connector 581 supported movably in the axial direction L with respect to the coupling portion 49 is restricted from moving to the axial second side L2 by the large diameter portion 48.

The support 582 rotatably supports the cam roller 551. The support 582 is formed to extend along the radial direction R. In the present embodiment, a plurality of supports 582 is dispersedly disposed in the circumferential direction C.

The guided portion 583 extends from the connector 581 toward the radial outside R2 and is coupled to the support 582. That is, the same number of the guided portions 583 as the supports 582 are provided. In the present embodiment, a plurality of guided portions 583 is dispersedly disposed in the circumferential direction C.

The guided portions 583 are disposed so as to penetrate the guide grooves 562 in the radial direction R. Therefore, the coupling member 58 is configured to be guided in the axial direction L in a state where the rotation in the circumferential direction C is restricted by an inner surface of the guide groove 562. That is, in the present embodiment, the guided portion 583 functions as the guide follower member 57.

FIG. 7 is a diagram in which the transmission member 51 in which the cam groove 542 is formed and the peripheral wall 31 of the tubular member 3 in which the guide groove 562 is formed are developed on a plane along the circumferential direction C and arranged so as to be aligned with each other in the circumferential direction C.

As shown in FIG. 7, in the present embodiment, the plurality of cam grooves 542 is disposed at equal intervals in the circumferential direction C. The plurality of guide grooves 562 is also disposed at equal intervals in the circumferential direction C. In the example shown in FIG. 7, two cam grooves 542 as the cam paths 54, two cam rollers 551 as the cam follower members 55, two guide grooves 562 as the guide paths 56, and two guided portions 583 as the guide follower members 57 are provided.

In the present embodiment, in a case where the rotational operation force is not input to the input member 1, each of the plurality of cam rollers 551 is located at a position (hereinafter, referred to as a “first position P1”) closest to the axial first side L1 in the cam groove 542. At this time, each of the plurality of guided portions 583 is at a position closest to the axial first side L1 in the guide groove 562.

Then, in a case where the rotational operation force is input to the input member 1, each of the plurality of cam rollers 551 is relatively movable to a position (hereinafter, referred to as a “second position P2”) closest to the axial second side L2 in the cam groove 542. In a case where the rotational operation force is input to the input member 1, each of the plurality of guided portions 583 is relatively movable to a position closest to the axial second side L2 in the guide groove 562.

In the present embodiment, a pair of surfaces facing both sides in the circumferential direction C in the guide groove 562 and a pair of surfaces facing both sides in the circumferential direction C in the guided portion 583 are formed in a planar shape such that the surfaces facing each other in the circumferential direction C are parallel to each other. In the present embodiment, since a dimension of the guided portion 583 in the circumferential direction C is set to be about the same as a dimension of the guide groove 562 in the circumferential direction C, the relative movement of the guided portion 583 with respect to the tubular member 3 in the circumferential direction C is restricted.

In the present embodiment, each of the plurality of cam grooves 542 is formed so as to gradually move toward the axial second side L2 toward the circumferential second side C2. Therefore, in the present embodiment, the linear motion conversion mechanism 5 converts the rotational motion of the transmission member 51 toward the circumferential first side C1 into the linear motion of the piston 4 toward the axial second side L2. The linear motion conversion mechanism 5 converts the linear motion of the piston 4 toward the axial first side L1 into the rotational motion of the transmission member 51 toward the circumferential second side C2. That is, in the present embodiment, when the rotational operation force is input to the input member 1 and the transmission member 51 rotates to the circumferential first side C1, the piston 4 moves to the axial second side L2 against the reaction force generated by the reaction force generation mechanism 2. On the other hand, in a case where the rotational operation force is not input to the input member 1, the reaction force generated by the reaction force generation mechanism 2 moves the piston 4 to the axial first side L1, and the transmission member 51 rotates to the circumferential second side C2 so that the input member 1 returns to the initial position.

Specifically, in a case where the rotational operation force is input to the input member 1 so that the transmission member 51 rotates to the circumferential first side C1, the cam roller 551 is pressed toward the circumferential first side C1 by the inner surface of the cam groove 542 formed in the transmission member 51 coupled to the input member 1. As a result, a force toward the circumferential first side C1 acts on the guided portion 583 coupled to the support 582 that supports the cam roller 551.

However, since the surface of the guided portion 583 facing the circumferential first side C1 abuts on the surface of the guide groove 562 facing the circumferential second side C2, the rotation of the coupling member 58 toward the circumferential first side C1 with respect to the tubular member 3 is restricted. Thus, each of the plurality of cam rollers 551 rolls from the first position P1 to the second position P2 of the cam groove 542 as the transmission member 51 rotates toward the circumferential first side C1. As a result, the piston 4 connected to the cam roller 551 via the coupling member 58 moves to the axial second side L2 against the reaction force generated by the reaction force generation mechanism 2.

On the other hand, in a case where the rotational operation force is no longer input to the input member 1 in a state where each of the cam rollers 551 is at the second position P2 of the cam groove 542, the coupling member 58 is pressed toward the axial first side L1 via the piston 4 by the reaction force generated by the reaction force generation mechanism 2. As a result, in a state where the rotation of the coupling member 58 in the circumferential direction C with respect to the tubular member 3 is restricted by the inner surface of the guide groove 562, as each of the plurality of cam rollers 551 rolls from the second position P2 to the first position P1 of the cam groove 542, the transmission member 51 rotates in the circumferential second side C2 so that the input member 1 returns to the initial position.

### 4. Modifiable Aspects

Aspects that are modifiable from the configurations disclosed in each of the above embodiments will be described. The configurations disclosed in the present specification, including the modifiable aspects described below and fourth to ninth embodiments described below, can also be applied in combination with the configurations disclosed in the other embodiments as long as no contradiction arises. The embodiments disclosed herein are merely exemplary in all respects. Therefore, various modifications can be appropriately made in each embodiment without departing from the spirit.
(1) In the above description, the configuration in which the transmission member 51 is coupled so as to rotate integrally with the input member 1 has been described as an example. However, the present disclosure is not limited to such a configuration. For example, as in the fourth embodiment and the like exemplified below, the input member 1 may be disposed on a shaft different from the transmission member 51 and coupled to the transmission member 51 via a link mechanism, a gear mechanism, or the like.
(2) In the above description, the configuration in which the linear motion conversion mechanism 5 includes the cam mechanism 52 and the guide mechanism 53 has been described as an example. However, the present disclosure is not limited to such a configuration, and the linear motion conversion mechanism 5 may include, for example, a crank mechanism, a ball screw mechanism, a rack and pinion, and the like as in the fourth embodiment and the like exemplified below.
(3) In the above description, the configuration in which the elastic member 6 includes two springs including the inner spring 61 (first elastic member) and the outer spring 62 (second elastic member) has been described as an example. However, the present disclosure is not limited to such a configuration, and although not exemplified in the following fourth to ninth embodiments, for example, the elastic member 6 may be configured by one or three or more springs, or may be configured by an elastic body other than a spring.
(4) In the above description, the configuration in which the friction member 7 is attached to the outer peripheral surface of the piston 4 has been described as an example. However, the present disclosure is not limited to such a configuration, and a configuration in which the friction member 7 is attached to the inner peripheral surface of the tubular member 3 may be adopted although not exemplified in the following fourth to ninth embodiments. In this configuration, the viscoelastic body 71 is preferably attached to the inner peripheral surface of the friction member 7.
(5) In the above description, the configuration in which the outer peripheral surface of the piston 4 includes the outer peripheral parallel surface 4c has been described as an example. However, the present disclosure is not limited to such a configuration. For example, as in the fourth embodiment and the like exemplified below, the outer peripheral surface of the piston 4 is not required to include the outer peripheral parallel surface 4c, that is, the outer peripheral inclined surface 4a and the outer peripheral restriction surface 4b may be continuously formed.

### 5. Feeling of Operation

In the above description, the description has been given focusing on appropriately performing a return operation to the initial position of the input member 1 in a case of moving the piston 4 to the axial first side L1 by a biasing force of the elastic member 6, that is, appropriately performing the movement of the piston 4 in different directions along the axial direction L while largely securing the reaction force by the reaction force generation mechanism 2 in a case of moving the piston 4 to the axial second side L2. However, by strengthening and weakening the reaction force generated by the reaction force generation mechanism 2 in the case of moving the piston 4 to the axial second side L2, it is possible to further improve a feeling of operation of the driver. For example, the feeling of operation of the pedal 19 as an operation tool includes elements such as (a) good response when the driver operates the pedal 19, (b) balance between stiffness and response, (c) reaction at a time of sudden operation, (d) holding of the pedal 19, and (e) ease of returning of the pedal 19. Hereinafter, also focusing on such points, the fourth to ninth embodiments will be described by way of example. Description of points similar to those of the first to third embodiments described above will be omitted as appropriate.

Here, for example, in a case where the pedal 19 is a brake pedal, the elements (a) to (e) correspond to the following. (a) The good response when the driver operates the pedal 19 corresponds to a beginning of an effect of a brake that is easily perceived by the driver. For example, this corresponds to setting of an appropriate starting load of the brake. (b) The balance between stiffness and response corresponds to stiffness and a degree of effect of the brake that the driver perceives. For example, this corresponds to an appropriate change in stiffness on the operation surface (on a pedal surface). (c) The reaction at the time of sudden operation corresponds to the reaction in a case where the pedal 19 is quickly stepped on at sudden braking and the like. This physically corresponds to application of an appropriate dynamic friction force to the operation of the pedal 19 (input member 1). (d) The holding of the pedal 19 is that the pedal 19 is appropriately held in response to the operation on the pedal 19 (input member 1). Physically, this corresponds to appropriate application of a static frictional force necessary for holding the pedal 19. (e) Ease of returning of the pedal 19 corresponds to controllability of the pedal 19 (input member 1) in a case where the driver weakens the operation force to the pedal 19, that is, in a case where the force applied to the pedal 19 is released. Physically, this corresponds to application of an appropriate frictional force that does not deteriorate returning of the pedal 19 (input member 1) to the initial position.

As described above, the reaction force generation mechanism 2 includes the inner spring 61 (first elastic member) that biases the piston 4 toward the axial first side L1, and the outer spring 62 (second biasing member) that biases the piston 4 toward the axial first side L1 with a biasing force (corresponding to a “spring coefficient” here) different from the inner spring 61. Here, in a case where the piston 4 moves to the axial second side L2 along the axial direction L with respect to the tubular member 3, a region where the inner spring 61 is mainly deformed is referred to as a first stroke region, and a region where the outer spring 62 is mainly deformed is referred to as a second stroke region. Here, the “region where the spring is mainly deformed” is not an absolute value of a deformation amount of the elastic member 6 (the first elastic member (inner spring 61) and the second elastic member (outer spring 62)) from a free length, but a region where the deformation amount of one elastic member (spring) according to a movement amount of the piston 4 is larger than the deformation amount of the other elastic member (spring).

The “first stroke region”, which is the “region where the first elastic member (inner spring 61) is mainly deformed”, is a region where a deformation ratio of the first elastic member (inner spring 61) is higher than a deformation ratio of the second elastic member (outer spring 62), and includes a region where only the first elastic member (inner spring 61) is deformed. The “second stroke region”, which is the “region where the second elastic member (outer spring 62) is mainly deformed”, is a region where the deformation ratio of the second elastic member (outer spring 62) is higher than the deformation ratio of the first elastic member (inner spring 61), and includes a region where only the second elastic member (outer spring 62) is deformed. In the present embodiment, both the first elastic member (inner spring 61) and the second elastic member (outer spring 62) are deformed in the first stroke region, and only the second elastic member (outer spring 62) is deformed in the second stroke region.

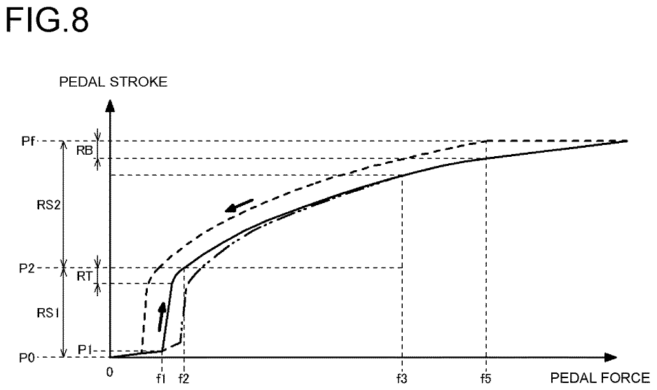

A graph in FIG. 8 shows a relationship between the operation force on the input member 1 (here, a pedal force on the pedal 19) and a movement amount (here, pedal stroke) of the input member 1. The pedal stroke indicates the position of the input member 1 between a state where the pedal force is not input to the pedal 19 and the input member 1 is located at an initial position “P0” and a full stroke position “Pf” where the pedal 19 is depressed to the maximum and the input member 1 is displaced to the maximum. As shown in FIG. 8, a characteristic curve indicates a different locus between when the pedal 19 is depressed indicated by a solid line and when the pedal 19 is returned indicated by a broken line, and has so-called hysteresis.

The pedal 19 is generally provided with play, and as shown in FIG. 8, the input member 1 hardly moves with respect to the input pedal force until the pedal force becomes “f1”. When the pedal force reaches “f1”, the input member 1 substantially starts to move (substantially the initial position “P1”) in accordance with the pedal force input to the pedal 19. A first stroke region RS1 is a displacement region of the input member 1 on a movement start side, that is, a displacement region of the input member 1 on the side where the position of the input member 1 is the initial position “P0”. A second stroke region RS2 is a displacement region on the full stroke position “Pf” side where the pedal 19 is most depressed.

As shown in FIG. 8, a change amount of the pedal stroke with respect to the pedal force is larger in the first stroke region RS1 than in the second stroke region RS2. As described above, the operation input device 100 exemplified in the present specification includes the reaction force generation mechanism 2 that generates a reaction force against the rotational operation force input to the input member 1 in any embodiment including the embodiment exemplified below, and the movement amount (stroke) of the input member 1 is affected by the reaction force. For example, in the first embodiment described above, in a case where the piston 4 starts to move to the axial second side L2 and the inner spring 61 contracts, the movement amount of the input member 1 is mainly affected by the reaction force due to the deformation of the inner spring 61 of the two springs. The first stroke region RS1 can be said to be a region where the inner spring 61 is mainly deformed. When the piston 4 further moves to the axial second side L2 and the outer spring 62 also starts to contract, the movement amount of the input member 1 is affected by the reaction force mainly due to the deformation of the outer spring 62 of the two springs. The second stroke region RS2 can be said to be a region where the outer spring 62 is mainly deformed.

As described above, the inner spring 61 and the outer spring 62 have biasing forces (spring constants) different from each other. In the reaction force generation mechanism 2 exemplified in the present specification, the biasing force of the outer spring 62 is larger than the biasing force of the inner spring 61. Therefore, the movement amount of the input member 1 per unit operation force is smaller in the second stroke region RS2 than in the first stroke region RS1 with respect to the operation force input to the input member 1. As a result, it is easy to give a certain feeling of operation to the driver who operates the pedal 19. For example, in a case where the pedal 19 is a brake pedal, the driver easily feels the effect of the brake by the reaction force that increases as the depression amount of the pedal 19 increases.

The gradient of the stroke change is different between the first stroke region RS1 where the deformation of the inner spring 61 mainly acts and the second stroke region RS2 where the deformation of the outer spring 62 mainly acts. When there is a difference between the gradient of the stroke change in the first stroke region RS1 and the gradient of the stroke change in the second stroke region RS2, the driver may feel uncomfortable during the transition from the first stroke region RS1 to the second stroke region RS2. Therefore, a transition region RT for alleviating a change in gradient is provided so that the pedal stroke does not cause a sudden change in gradient at the time of transition from the first stroke region RS1 to the second stroke region RS2. In the reaction force generation mechanism 2 exemplified in the present specification, the transition region RT is provided before the transition to the second stroke region RS2, and the transition region RT is included in the first stroke region RS1.

In the reaction force generation mechanism 2 exemplified in the present specification, the transition region RT is implemented by using an elastic member (rubber in this case) functioning as a damper. For example, in the first to third embodiments, when the piston 4 moves to the axial second side L2 and the inner spring 61 contracts, a first damper rubber 68 (see FIGS. 2, 5, and 6) abuts on the inner holder 82. When the piston 4 further moves to the axial second side L2, the first damper rubber 68 contracts. When the piston 4 further moves to the axial second side L2, the holding member 8 also starts to move to the axial second side L2, and the outer spring 62 also starts to contract. In general, a change range of the pedal stroke before the first damper rubber 68 comes into contact with the inner holder 82 and starts to contract and the outer spring 62 starts to contract corresponds to the transition region RT. In order to smoothly connect the first stroke region RS1 and the second stroke region RS2 having different gradients, the change in gradient in the transition region RT is preferably nonlinear with respect to the pedal force (operation force).

Such a damper is also provided to provide a bottoming region RB at an end of the second stroke region RS2. An elastic member (rubber in this case) for implementing the bottoming region RB is a second damper rubber 69 (see FIGS. 2, 5, and 6). For example, in the first to third embodiments, when the piston 4 and the holding member 8 move to the axial second side L2 and the outer spring 62 contracts, the second damper rubber 69 comes into contact with the bottom wall 32 of the tubular member 3. Furthermore, when the piston 4 and the holding member 8 move to the axial second side L2, the second damper rubber 69 contracts. In general, a change range of the pedal stroke after the second damper rubber 69 comes into contact with the bottom wall 32 and starts to contract corresponds to the bottoming region RB.

As shown in FIG. 8, when the position of the input member 1 is at and after “P1” (the pedal force is at and after “f1”), the pedal stroke of the input member 1 increases substantially linearly with respect to the pedal force. Mainly by appropriately setting the biasing force of the inner spring 61 (low spring constant, so-called low spring), an appropriate starting load can be applied (implementation of element (a)). The stroke change indicated by a two-dot chain line in FIG. 8 exemplifies a case where the driver performs an early operation (for example, sudden braking). In this case, since an appropriate dynamic friction force (for example, the operation frictional force by the friction member 7) is applied, it is possible to give a feeling of operation to the driver and to suppress generation of a feeling of misstep by the driver (implementation of element (c)).

The position “P2” of the input member 1 is an end point of the first stroke region RS1 and a start point of the second stroke region RS2. The pedal force at this time is “f2”. The pedal force “f3” is a maximum pedal force in the specification on a dry path. In the second stroke region RS2, particularly between the pedal force “f2” and “f3”, the holding of the input member 1 is secured by, for example, application of the static frictional force by the friction member 7 (implementation of element (d)). The pedal stroke is changed with an appropriate gradient mainly by appropriately setting the biasing force of the outer spring 62 (setting a spring constant higher than the spring constant of the inner spring 61). As a result, the effect of the brake and the application of the stiffness to the driver can be balanced (implementation of element (d)).

The pedal force “f5” is a pedal force for moving the input member 1 until the second damper rubber 69 substantially comes into contact with the bottom wall 32. When the driver further applies a pedal force to the pedal 19 beyond the pedal force “f5”, the second damper rubber 69 contracts. As a result, a higher reaction force is secured, and it is possible to give the driver a feeling of operation with a maximum amount of depression.

As shown in FIG. 8, the characteristic curve indicates a different locus between when the pedal 19 is depressed indicated by a solid line and when the pedal 19 is returned indicated by a broken line, and has so-called hysteresis. As described above, by applying an appropriate frictional force to the friction member 7, controllability of the input member 1 when the driver weakens the operation force by the pedal 19, that is, when the force applied to the pedal 19 is released is secured (implementation of element (e)).

Here, a movement amount of the piston 4 with respect to a rotation amount of the input member 1 to which the rotational operation force is input (a rotation angle and an arc trajectory centered on a reference point (such as a swing axis)) is defined as a rotation linear motion conversion ratio (“rotation amount (rotation angle)/linear movement amount”, which is appropriately abbreviated as “linear motion conversion ratio”) of the linear motion conversion mechanism 5. Then, a value obtained by dividing a difference between the linear motion conversion ratio of a first start, which is a start of the first stroke region RS1, and the linear motion conversion ratio of a first end, which is an end of the first stroke region, by the linear motion conversion ratio of the first start is set as a first variable rate. A value obtained by dividing a difference between the linear motion conversion ratio of a second start, which is a start of the second stroke region RS2, and the linear motion conversion ratio of a second end, which is an end of the second stroke region, by the linear motion conversion ratio of the second start is set as a second variable rate.

As described above with reference to FIG. 8, since it is the position “P1” at which the input member 1 substantially starts moving in consideration of play, the “first start” corresponds to the pedal stroke at which the input member 1 is located at the position “P1”. The “first end” and the “second start” are the position “P2” corresponding to the same pedal stroke. The “second end” corresponds to a pedal stroke in which the position of the input member 1 is the full stroke position “Pf”.

By displacing in a direction in which the reaction force becomes stronger with respect to a rotation operation amount, it is easy for the driver to perceive the feeling of operation. Therefore, the linear motion conversion ratio shifts in a direction of decreasing as the rotation operation amount increases. The linear motion conversion ratio of the first end is equal to or less than the linear motion conversion ratio of the first start, and the linear motion conversion ratio of the second end is less than the linear motion conversion ratio of the second start. Since the first stroke region RS1 and the second stroke region RS2 are continuous, the linear motion conversion ratio of the second start is the same as the linear motion conversion ratio of the first end. The first variable rate is an index indicating a change in a direction in which the rotation linear motion conversion ratio is the same or decreases, and the second variable rate is an index indicating a change rate in a direction in which the rotation linear motion conversion ratio decreases. Then, the linear motion conversion mechanism 5 is configured such that the second variable rate is higher than the first variable rate.

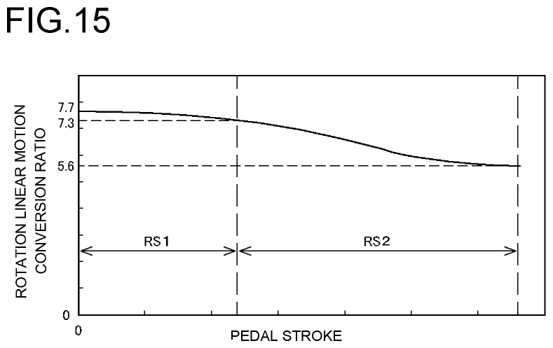

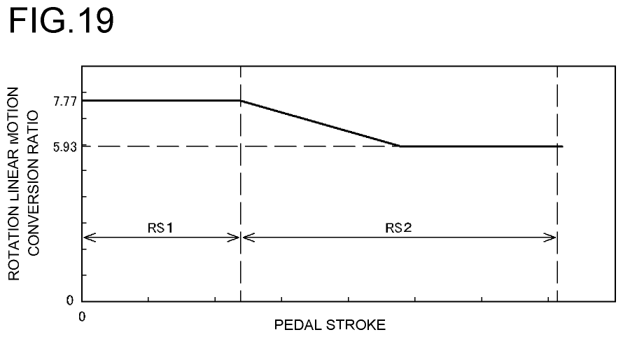

Although a specific example will be described later with reference to a graph showing a change in the linear motion conversion ratio (FIGS. 15 and 19: the eighth embodiment and the ninth embodiment), the second variable rate is preferably 20% or more. As the rotation angle of the input member 1 increases in the second stroke region RS2, the reaction force increases, and an operator more easily perceives a certain feeling of operation. The linearity between the rotational motion and the linear motion is lower in the second stroke region RS2 than in the first stroke region RS1 (particularly, FIG. 15). As described above, the operation input device 100 can make the driver perceive the feeling of operation more easily.

In the forms exemplified in FIGS. 15 and 19, as will be described later, a form is exemplified in which the first variable rate is “5.2%” and “0%”, respectively, and in the present specification, a form is exemplified in which the first variable rate is zero or more. However, the first variable rate includes a case where “the linear motion conversion ratio of the first start <the linear motion conversion ratio of the first end”, which is a value less than zero (negative value). That is, the linear motion conversion mechanism 5 is configured such that the second variable rate is higher on the positive side than the first variable rate.

### 6. Another Example of Form of Rotation Linear Motion Conversion (Watt Link Mechanism)

Hereinafter, the operation input device 100 according to the fourth to ninth embodiments will be described. Before the description of the individual embodiments, the structure of the linear motion conversion mechanism 5 in the operation input device 100 according to the fourth to seventh embodiments will be described. The operation input device 100 according to the fourth to seventh embodiments is different from those according to the first to third embodiments described above in the form of power transmission from the input member 1 to the reaction force generation mechanism 2. In the first to third embodiments, a form is exemplified in which the swing axis Y at which the input member 1 swings and the reference axis X of the linear motion conversion mechanism 5 are coaxial. However, as shown in FIG. 9, in the fourth to seventh embodiments, the swing axis Y and the reference axis X are different axes. The reference axis X is orthogonal to the swing axis Y.

In the first embodiment, in the linear motion conversion mechanism 5, the cam mechanism 52 converts the rotational motion of the input member 1 into a linear motion in a direction along the rotational axis (swing axis Y) of the rotational motion. That is, the cam mechanism 52 mutually converts the rotational motion of the transmission member 51, which is a shaft member to which the rotation of the input member 1 about the swing axis Y (=reference axis X) is transmitted, and the linear motion along the reference axis X. In the fourth to seventh embodiments, the rotational motion of the input member 1 is converted into a linear motion via a watt link mechanism 20 (watt linkage) which is a mechanism capable of creating an approximate straight line within a specific range.

The watt link mechanism 20 includes a first link axis W1 and a second link axis W2 as fixed axes, and includes a third link axis W3 and a fourth link axis W4 as follower axes. The first link axis W1, the second link axis W2, the third link axis W3, and the fourth link axis W4 are different axes parallel to each other, and are simply referred to as “link axis” when not distinguished from each other. The first link axis W1 coincides with the swing axis Y. The swing axis Y is orthogonal to the reference axis X, and each link axis is orthogonal to the reference axis X. The third link axis W3 and the fourth link axis W4 are disposed on the reference axis X in a state where the input member 1 is at the initial position as viewed in a direction along the link axis.

The first link axis W1 and the third link axis W3 are coupled by a first link joint 21, the second link axis W2 and the fourth link axis W4 are coupled by a second link joint 22, and the third link axis W3 and the fourth link axis W4 are coupled by a third link joint 23. The first link joint 21, the second link joint 22, and the third link joint 23 are swingable about the axis to which each link joint is coupled.

A clevis 24 is swingably coupled to the fourth link axis W4, and the clevis 24 is coupled to the piston 4 via a pin head 25. When the third link joint 23 performs an approximate linear motion along the reference axis X in accordance with the swing of the input member 1 about the first link axis W1 (swing axis Y), the fourth link axis W4 also performs an approximate linear motion along the reference axis X, and the clevis 24 performs a linear motion along the reference axis X. As a result, the piston 4 coupled to the clevis 24 via the pin head 25 performs a linear motion along the reference axis X. In this manner, the linear motion conversion mechanism 5 according to the fourth to seventh embodiments converts the rotational motion of the input member 1 into the linear motion by using the conversion mechanism having the watt link mechanism 20 as a core.

### 7. Fourth embodiment

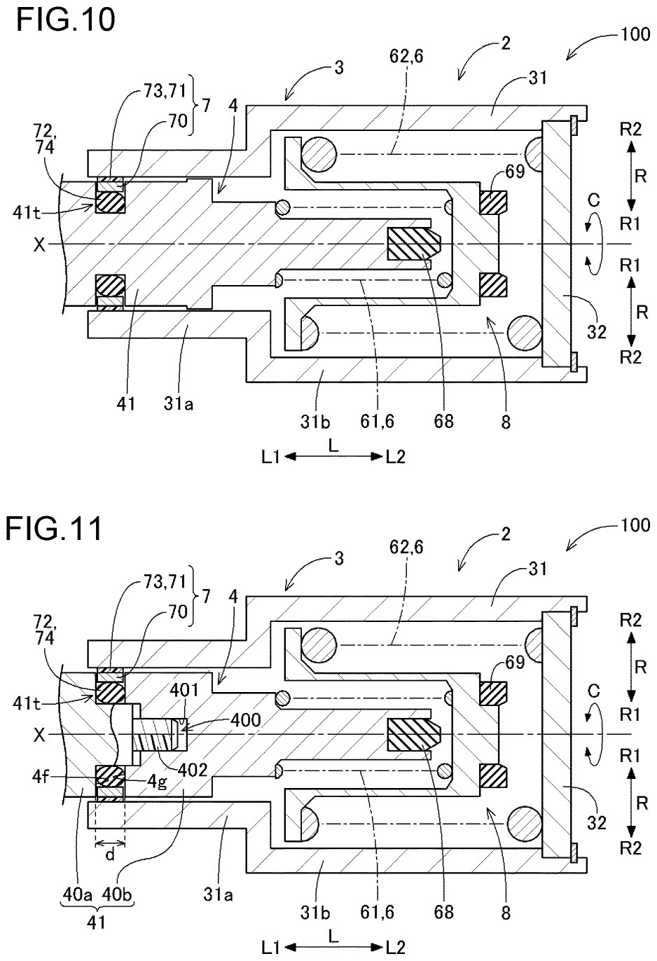

FIG. 10 is a sectional view along the axial direction L of the operation input device according to the fourth embodiment. As described above, the operation input device 100 according to the fourth embodiment performs rotational linear motion conversion by the watt link mechanism 20. Hereinafter, a structure related to the linear motion of the piston 4 will be described. Description of matters common to the matters described in the first to third embodiments will be omitted as appropriate. In the first embodiment (and the second embodiment), the piston 4 includes the plate-shaped slider 41 having a relatively short dimension in the axial direction L. In the fourth embodiment, the piston 4 includes a long shaft-shaped slider 41 having a longer dimension in the axial direction L than in the first embodiment.

In the first embodiment (and the second embodiment), the tubular member 3 accommodating the piston 4 therein has a tubular shape having the same diameter, but in the fourth embodiment, the peripheral wall 31 has a stepped tubular shape including a first peripheral wall 31a and a second peripheral wall 31b having different diameters. The first peripheral wall 31a is disposed on the axial first side L1 with respect to the second peripheral wall 31b. The diameter of the second peripheral wall 31b is larger than the diameter of the first peripheral wall 31a. The second peripheral wall 31b is formed to have a larger diameter than the first peripheral wall 31a in order to accommodate the outer spring 62 on the radial inside R1.

In the first embodiment and the second embodiment (see FIGS. 2 and 5), a form is exemplified in which the bottom wall 32 of the tubular member 3 is integrally formed by the same member as the peripheral wall 31. However, in the fourth embodiment (and fifth to seventh embodiments to be described later), as shown in FIG. 10 (and FIGS. 11 to 13), a form is exemplified in which the bottom wall 32 is formed by a member different from the peripheral wall 31 and is coupled so as to be integrated with the peripheral wall 31. The bottom wall 32 may also be configured by a member different from the peripheral wall 31 in the first embodiment and the second embodiment, or may also be integrally formed with the same member as the peripheral wall 31 in the fourth embodiment (and the fifth to seventh embodiments).

The piston 4 accommodated in the tubular member 3 slides along the axial direction L on an inner peripheral surface of the first peripheral wall 31a. Then, the reaction force generation mechanism 2 includes the friction member 7 disposed at the sliding portion between the outer peripheral surface of the piston 4 (the outer peripheral surface of the shaft-shaped slider 41) and the inner peripheral surface of the tubular member 3 (the inner peripheral surface of the first peripheral wall 31a), and a strained force application mechanism 74 that presses the friction member 7 from the radial inside R1 toward the radial outside R2 to apply a strained force to the inner peripheral surface of the tubular member 3. In the slider 41, an annular friction member arrangement groove 41t recessed toward the radial inside R1 from the outer peripheral surface of the shaft-shaped slider 41 is formed. The friction member 7 is disposed in the friction member arrangement groove 41t. The friction member 7 includes a sliding member 73 disposed on a sliding surface between the tubular member 3 and the piston 4, and a base material 70 to which the sliding member 73 is bonded on the radial outside R2. In the friction member arrangement groove 41t, the elastic body 72 (annular elastic body) functioning as the strained force application mechanism 74 is also disposed. The elastic body 72 is disposed on the radial inside R1 of the base material 70, and presses the base material 70 together with the sliding member 73 toward the radial outside R2 by an elastic force. That is, the strained force application mechanism 74 presses the base material 70 on which the sliding member 73 is disposed on the radial outside R2 from the radial inside R1 toward the radial outside R2. In other words, the strained force application mechanism 74 presses the base material 70 from the side where the base material 70 is disposed toward the side where the sliding member 73 is disposed along the radial direction R. Note that, as in the second embodiment described with reference to FIG. 5, for example, an O-ring can be used as the elastic body 72.

FIG. 10 exemplifies a form in which the reaction force generation mechanism 2 includes the strained force application mechanism 74 that presses the friction member 7 from the radial inside R1 toward the radial outside R2 to apply a strained force to the inner peripheral surface of the tubular member 3. However, although not shown, the reaction force generation mechanism 2 may include a strained force application mechanism 74 that presses the friction member 7 from the radial outside R2 toward the radial inside R1 to apply a strained force to the outer peripheral surface of the piston 4. In this case, the strained force application mechanism 74 presses the base material 70 from the radial outside R2 toward the radial inside R1. Specifically, an annular friction member arrangement groove recessed toward the radial outside R2 from the inner peripheral surface of the tubular member 3 is formed, and the friction member 7 is disposed in the friction member arrangement groove. The friction member 7 includes the sliding member 73 disposed on the sliding surface between the piston 4 and the tubular member 3, and the base material 70 to which the sliding member 73 is bonded on the radial inside R1. In the friction member arrangement groove, the elastic body 72 (annular elastic body) functioning as the strained force application mechanism 74 is disposed. The elastic body 72 is disposed on the radial outside R2 of the base material 70, and presses the base material 70 together with the sliding member 73 toward the radial inside R1 by an elastic force. That is, the strained force application mechanism 74 presses the base material 70 on which the sliding member 73 is disposed on the radial inside R1 from the radial outside R2 toward the radial inside R1. In this case, the strained force application mechanism 74 also presses the base material 70 from the side where the base material 70 is disposed toward the side where the sliding member 73 is disposed along the radial direction R. In this case, for example, an O-ring can also be used as the elastic body 72.

As in the first embodiment and the second embodiment, the sliding member 73 is preferably the viscoelastic body 71.

### 8. Fifth Embodiment

Next, an operation input device 100 according to the fifth embodiment will be described with reference to FIG. 11. The fifth embodiment is different from the fourth embodiment in the configuration of the reaction force generation mechanism 2, specifically, the configuration of the piston 4. Hereinafter, differences from the fourth embodiment will be mainly described. Note that points not specifically described are obvious from the above description of each embodiment, and thus the description thereof will be appropriately omitted.

As shown in FIG. 11, in the fifth embodiment, the piston 4 includes two members, a first member 40a and a second member 40b. Specifically, the shaft-shaped slider 41 of the piston 4 is divided into the first member 40a and the second member 40b. The first member 40a is disposed relatively on the axial first side L1, and the second member 40b is disposed relatively on the axial second side L2. On the axial first side L1 of the second member 40b, a screw hole 401 is formed on the reference axis X, and a female screw groove is formed in an inner peripheral wall of the screw hole 401. On the axial second side L2 of the first member 40a, a male screw portion 402 disposed on the reference axis X and protruding toward the axial second side L2 is formed. The male screw portion 402 is formed so as to protrude toward the axial second side L2 from a flange surface 4f extending to an outer peripheral surface on the radial outside R2 of the shaft-shaped first member 40a. A male screw groove is formed in an outer peripheral wall of the male screw portion 402 on the axial second side L2. By screwing the male screw portion 402 into the screw hole 401, the first member 40a and the second member 40b are coupled, and the piston 4 is integrally formed.

In the fifth embodiment, the friction member arrangement groove 41t in which the friction member 7 and the elastic body 72 as the strained force application mechanism 74 are disposed is formed between an opposing end surface 4g which is an end surface on the axial first side L1 of the second member 40b opposing the first member 40a and the flange surface 4f of the first member 40a. A width of the friction member arrangement groove 41t, that is, a groove width d, which is a dimension along the axial direction L, changes depending on a depth (length) of the male screw portion 402 screwed into the screw hole 401. When the male screw portion 402 is screwed deeply into the screw hole 401, the arrangement positions of the first member 40a and the second member 40b in the axial direction L approach each other, and a separation distance between the opposing end surface 4g and the flange surface 4f is reduced. As a result, the groove width d is narrowed. In contrast, when the male screw portion 402 is shallowly screwed into the screw hole 401, the arrangement positions of the first member 40a and the second member 40b in the axial direction L are separated from each other, and the separation distance between the opposing end surface 4g and the flange surface 4f is increased. As a result, the groove width d is increased.

When the groove width d is narrowed, the elastic body 72 is compressed in the axial direction L and extends in the radial direction R. Since a base of the male screw portion 402 of the first member 40a is located on the radial inside R1 of the friction member arrangement groove 41t, the extension of the elastic body 72 toward the radial inside R1 is restricted, and the elastic body 72 extends toward the radial outside R2. Therefore, the strained force by the elastic body 72 (annular elastic body) functioning as the strained force application mechanism 74 becomes strong. Note that, in a case where the extension to the radial inside R1 is not restricted as described above and the elastic body 72 extends to both sides in the radial direction R, the strained force to the radial outside R2 also becomes strong to some extent. In contrast, when the groove width d increases, the strained force of the elastic body 72 decreases.

That is, the reaction force generation mechanism 2 of the operation input device 100 according to the fifth embodiment includes the male screw portion 402 and the screw hole 401, and includes a position adjustment mechanism 400 that adjusts the arrangement positions of the first member 40a and the second member 40b in the axial direction L. Then, by adjusting the arrangement positions of the first member 40a and the second member 40b by the position adjustment mechanism 400, the strained force by the strained force application mechanism 74 configured by the annular elastic body 72 is also adjusted. That is, it can be said that the reaction force generation mechanism 2 of the operation input device 100 according to the fifth embodiment includes a strained force adjustment mechanism capable of adjusting the strained force applied to the friction member 7, and the strained force adjustment mechanism is configured by the position adjustment mechanism 400.

In the fourth embodiment and the fifth embodiment, the strained force applied to the friction member 7 is substantially the same in a case where the piston 4 moves in any direction in the axial direction L. That is, the strained force is substantially constant between a case where the driver steps on the pedal 19 and a case where the pedal 19 returns to the initial position, and a large effect cannot be expected as for the hysteresis (corresponding to element (e)) as described with reference to FIG. 8. However, the effect as for the rotation linear motion conversion ratio and the like in the first stroke region RS1 and the second stroke region RS2 can be sufficiently expected (corresponding to the elements (a) to (d)).

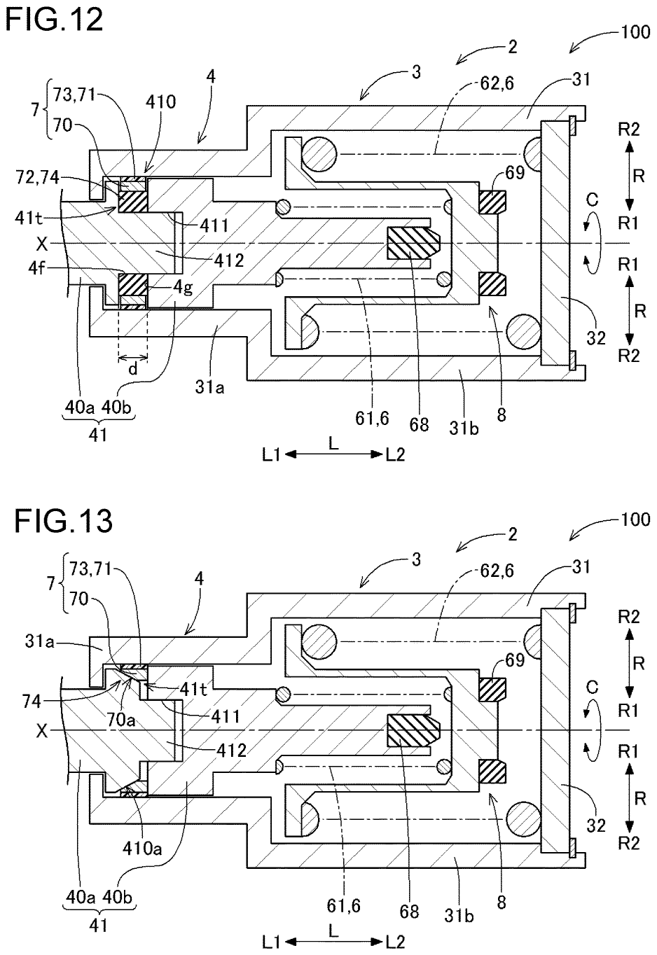

Hereinafter, in the sixth embodiment and the seventh embodiment described with reference to FIGS. 12 and 13, the strained force applied to the friction member 7 changes in accordance with the pedal stroke. Therefore, the effects of elements (a) to (e) can be obtained.

### 9. Sixth Embodiment

As in the fifth embodiment, in the sixth embodiment, as shown in FIG. 12, the piston 4 also includes two members, the first member 40a and the second member 40b. That is, the shaft-shaped slider 41 of the piston 4 is divided into the first member 40a disposed relatively on the axial first side L1 and the second member 40b disposed relatively on the axial second side L2. In the fifth embodiment, the first member 40a and the second member 40b are coupled via a screw adjustment mechanism (position adjustment mechanism 400) so as not to move relative to each other during operation of the linear motion conversion mechanism 5. However, in the sixth embodiment, the first member 40a and the second member 40b are coupled so as to be still relatively movable along the axial direction L during the operation of the linear motion conversion mechanism 5.

As shown in FIG. 12, an engagement hole 411 is formed on the reference axis X on the axial first side L1 of the second member 40b. On the axial second side L2 of the first member 40a, a protrusion 412 disposed on the reference axis X and protruding toward the axial second side L2 is formed. The protrusion 412 is formed so as to protrude toward the axial second side L2 from a flange surface 4f extending to an outer peripheral surface on the radial outside R2 of the shaft-shaped first member 40a. When the protrusion 412 is engaged with the engagement hole 411, the first member 40a and the second member 40b are coupled in a state of being relatively movable in the axial direction L, and the piston 4 is integrally configured. An outer diameter of the protrusion 412 is smaller than an inner diameter of the engagement hole 411, and the protrusion 412 is slidable with respect to the engagement hole 411.

In the sixth embodiment, the friction member arrangement groove 41t in which the friction member 7 and the elastic body 72 as the strained force application mechanism 74 are disposed is formed between the opposing end surface 4g which is the end surface on the axial first side L1 of the second member 40b opposing the first member 40a and the flange surface 4f of the first member 40a. The width of the friction member arrangement groove 41t, that is, the groove width d, which is the dimension along the axial direction L, changes depending on an engagement depth of the protrusion 412 with respect to the engagement hole 411. When the protrusion 412 is deeply inserted into the engagement hole 411, the arrangement positions of the first member 40a and the second member 40b in the axial direction L approach each other, and the separation distance between the opposing end surface 4g and the flange surface 4f is reduced. As a result, the groove width d is narrowed. In contrast, when the protrusion 412 is inserted shallowly into the engagement hole 411, the arrangement positions of the first member 40a and the second member 40b in the axial direction L are separated from each other, and the separation distance between the opposing end surface 4g and the flange surface 4f is increased. As a result, the groove width d is increased.

When the groove width d is narrowed, the elastic body 72 is compressed in the axial direction L and extends in the radial direction R. Since the protrusion 412 of the first member 40a is located on the radial inside R1 of the friction member arrangement groove 41t, the extension of the elastic body 72 toward the radial inside R1 is restricted, and the elastic body 72 extends toward the radial outside R2. Therefore, the strained force by the elastic body 72 (annular elastic body) functioning as the strained force application mechanism 74 becomes strong. Note that, in a case where the extension to the radial inside R1 is not restricted as described above and the elastic body 72 extends to both sides in the radial direction R, the strained force to the radial outside R2 also becomes strong to some extent. In contrast, when the groove width d increases, the strained force of the elastic body 72 decreases.

The protrusion 412 moves to the axial second side L2 as operation input from the input member 1 becomes stronger. That is, as the operation input by the driver becomes stronger, the protrusion 412 moves to the axial second side L2, compresses the elastic body 72 in the axial direction L, the strained force to the radial outside R2 becomes stronger, and the reaction force becomes stronger. When a distal end of the protrusion 412 on the axial second side L2 abuts on a bottom of the engagement hole 411, the relative movement between the first member 40a and the second member 40b is restricted. When the rotational operation force is not input and a positional relationship between the first member 40a and the second member 40b along the axial direction L is in an initial state, the separation distance in the axial direction L between the distal end of the protrusion 412 on the axial second side L2 and the bottom of the engagement hole 411 is set to be shorter than the groove width d. As a result, a function as a stopper for the relative movement between the first member 40a and the second member 40b is implemented, and the compression of the elastic body 72 in the axial direction L can be restricted in a state where a compression force is smaller than a compression limit of the elastic body 72 in the axial direction L. In other words, it is possible to limit the strained force while amplifying the strained force toward the radial outside R2.

That is, in the operation input device 100 according to the sixth embodiment, it can be said that the reaction force generation mechanism 2 includes a strained force amplification mechanism 410 capable of amplifying the strained force applied to the friction member 7 as a linear motion operation force that moves the piston 4 to the axial second side L2 along the axial direction L increases. As described above, the piston 4 includes the first member 40a disposed on the axial first side L1 and the second member 40b disposed on the axial second side L2 so as to be relatively movable in the axial direction L with respect to the first member 40a. The strained force application mechanism 74 includes the elastic body 72 (annular elastic body) disposed between the first member 40a and the second member 40b in the axial direction L. Then, the strained force amplification mechanism 410 includes the divided piston 4 and the elastic body 72 (annular elastic body). The elastic body 72 functions as the strained force application mechanism 74 that applies a strained force to the radial outside R2, and also functions as the strained force amplification mechanism 410 in which the strained force to the radial outside R2 increases as the separation distance (which may be considered as the groove width d) between the first member 40a and the second member 40b in the axial direction L decreases.

As for the return (when the operation is not input to the input member 1), the elastic force of the elastic body 72 also acts in a direction in which the first member 40a and the second member 40b are separated from each other. As a result, since the strained force is reduced, the piston 4 can move with a lower strained force when moving to the axial first side L1 than when moving to the axial second side L2. Therefore, the input member 1 can be quickly returned to the initial position.

### 10. Seventh Embodiment

As in the fifth and sixth embodiments, as shown in FIG. 13 in the seventh embodiment, the piston 4 includes two members, the first member 40a and the second member 40b. That is, the shaft-shaped slider 41 of the piston 4 is divided into the first member 40a disposed relatively on the axial first side L1 and the second member 40b disposed relatively on the axial second side L2. In the seventh embodiment, as in the sixth embodiment, the first member 40a and the second member 40b are coupled so as to be relatively movable along the axial direction L.

As shown in FIG. 13, an engagement hole 411 is formed on the reference axis X on the axial first side L1 of the second member 40b. On the axial second side L2 of the first member 40a, a protrusion 412 disposed on the reference axis X and protruding toward the axial second side L2 is formed. When the protrusion 412 is engaged with the engagement hole 411, the first member 40a and the second member 40b are coupled, and the piston 4 is integrally configured. An outer diameter of the protrusion 412 is smaller than an inner diameter of the engagement hole 411, and the protrusion 412 is slidable with respect to the engagement hole 411.

In the sixth embodiment, a bottom of the radial inside R1 of the friction member arrangement groove 41t is a surface parallel to the axial direction L, but in the seventh embodiment, the bottom is an inclined surface (first member outer peripheral inclined surface 410a) inclined with respect to the axial direction L. The first member outer peripheral inclined surface 410a is inclined to the radial inside R1 toward the axial second side L2. In the sixth embodiment and the like, a sectional shape of the base material 70 is rectangular, but in the seventh embodiment, the surface of the radial inside R1 of the base material 70 is also a tapered surface (an inclined surface in the sectional shape) in accordance with the shape of the friction member arrangement groove 41t (base material inner peripheral inclined surface 70a). The base material inner peripheral inclined surface 70a is inclined to the radial inside R1 toward the axial second side L2. Then, the first member outer peripheral inclined surface 410a and the base material inner peripheral inclined surface 70a face each other in the radial direction R and are in contact with each other.

As in the sixth embodiment, the relative position of the first member 40a and the second member 40b in the axial direction L changes depending on the engagement depth of the protrusion 412 with respect to the engagement hole 411. When the protrusion 412 is deeply inserted into the engagement hole 411, the arrangement positions of the first member 40a and the second member 40b in the axial direction L approach each other. In contrast, when the protrusion 412 is shallowly inserted into the engagement hole 411, the arrangement positions of the first member 40a and the second member 40b in the axial direction L separate from each other.

When the arrangement positions of the first member 40a and the second member 40b in the axial direction L approach each other, the first member outer peripheral inclined surface 410a comes into contact with the first member on the axial first side L1, and the base material inner peripheral inclined surface 70a comes into contact with the second member on the axial second side L2. That is, the first member 40a and the base material 70 come into contact with each other at a position where the dimension in the radial direction R increases, and the force by which the base material 70 is pushed out to the radial outside R2 by the first member 40a, that is, the strained force to the radial outside R2 increases. As shown in FIG. 13, in the seventh embodiment, the annular elastic body 72 is not disposed between the first member 40a and the base material 70. In the sixth embodiment, the annular elastic body 72 functions as the strained force application mechanism 74, but in the seventh embodiment, the divided piston 4 and the base material 70 function as the strained force application mechanism 74.

In the operation input device 100 according to the seventh embodiment, as described above, the piston 4 includes the first member 40a disposed on the axial first side L1 and the second member 40b disposed on the axial second side L2 so as to be relatively movable in the axial direction L with respect to the first member 40a. The outer peripheral surface of the first member 40a includes the first member outer peripheral inclined surface 410a (outer peripheral inclined surface) inclined to the radial inside R1 toward the axial second side L2. The base material 70 includes the base material inner peripheral inclined surface 70a (inner peripheral inclined surface) inclined to the radial inside R1 toward the axial second side L2 on the radial inside R1. The base material 70 is disposed between the first member 40a and the second member 40b in the axial direction L and between the first member outer peripheral inclined surface 410a and the inner peripheral surface of the tubular member 3 such that the base material inner peripheral inclined surface 70a is engaged with the first member outer peripheral inclined surface 410a. The strained force application mechanism 74 applies a strained force to the inner peripheral surface of the tubular member 3 by changing the position in the axial direction L where the first member outer peripheral inclined surface 410a and the base material inner peripheral inclined surface 70a are in contact with each other along with the movement of the piston 4 toward the axial second side L2.

As for the return (when there is no operation input to the input member 1), slip occurs in an engagement portion (contact portion) between the first member outer peripheral inclined surface 410a and the base material inner peripheral inclined surface 70a due to a stress in the radial direction R transmitted from the inner peripheral surface of the tubular member 3 to the first member outer peripheral inclined surface 410a via the base material 70, and accordingly, the first member 40a and the second member 40b are separated from each other. Since the first member 40a and the second member 40b are separated from each other to reduce the strained force, the input member 1 can be returned to the initial position while the strained force is reduced. In the seventh embodiment in which the elastic body 72 is not provided, it is preferable to set, on the first member outer peripheral inclined surface 410a and the base material inner peripheral inclined surface 70a, an inclination angle at which sliding of the engagement portion (contact portion) appropriately occurs due to a pressing force in the engagement portion (contact portion) between the first member outer peripheral inclined surface 410a and the base material inner peripheral inclined surface 70a for generating a strained force and a stress from the inner peripheral surface of the tubular member 3.

### 11. Eighth Embodiment

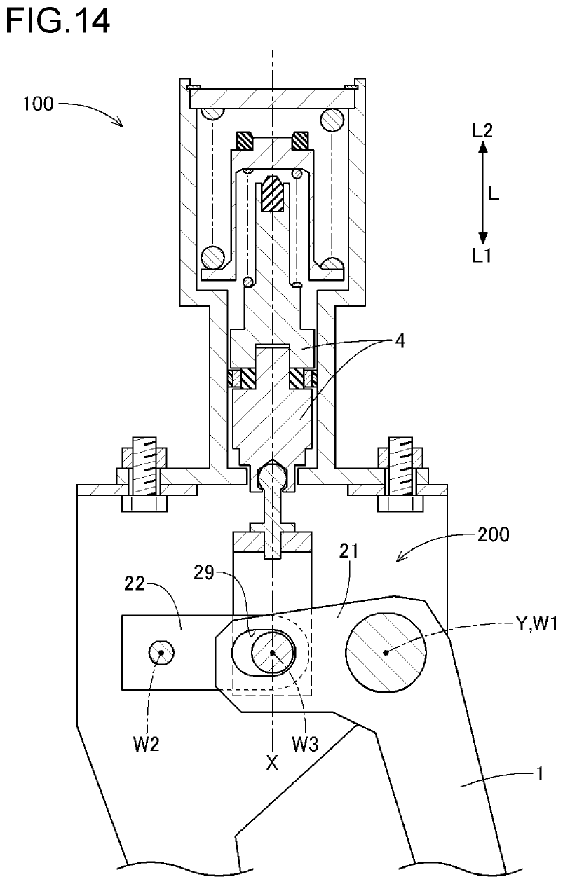

As a configuration example of the linear motion conversion mechanism 5, a form using the cam roller has been exemplified in the first to third embodiments, and a form using the watt link mechanism 20 has been exemplified in the fourth to seventh embodiments. However, the linear motion conversion mechanism 5 is not limited to these forms, and may be a form (composite mechanism 200) using the principle of the link mechanism and the cam as exemplified in FIG. 14.

Similar to the watt link mechanism 20 described above with reference to FIG. 9, the composite mechanism 200 includes the first link axis W1 and the second link axis W2 as fixed axes. The composite mechanism 200 includes the third link axis W3 as a follower axis. The first link axis W1 coincides with the swing axis Y of the input member 1. The first link axis W1 is orthogonal to the reference axis X, and each link axis (the second link axis W2 and the third link axis W3) is also orthogonal to the reference axis X. The third link axis W3 is disposed on the reference axis X in a state where the input member 1 is at the initial position as viewed in a direction along the link axis.

The first link axis W1 and the third link axis W3 are coupled by the first link joint 21, and the second link axis W2 and the third link axis W3 are coupled by the second link joint 22. The third link axis W3 is disposed in a link cam groove 29 formed in the first link joint 21. When the input member 1 swings clockwise in the drawing about the first link axis W1, the third link axis W3 moves to the axial second side L2 at a certain position in the link cam groove 29 (the input member 1 side in the link cam groove 29 in FIG. 13), and the second link joint 22 swings about the second link axis W2 as a swing center. When a swing angle of the input member 1 exceeds a reference value, the third link axis W3 moves in the link cam groove 29 (moves to an opposite side to the input member 1 in the link cam groove 29 in FIG. 13). When the third link axis W3 moves in the link cam groove 29, the rotation linear motion conversion ratio can be made different.

FIG. 15 is a graph showing an example of the rotation linear motion conversion ratio (=rotation angle/linear movement amount) of the operation input device 100 according to the eighth embodiment. The horizontal axis indicates the pedal stroke, and the vertical axis indicates the rotation linear motion conversion ratio. The swing angle (pedal stroke) of the input member 1 in which the third link axis W3 moves in the link cam groove 29 generally corresponds to a boundary between the first stroke region RS1 and the second stroke region RS2.

As shown in FIG. 15, in the first stroke region RS1, the rotation linear motion conversion ratio changes from “7.7” of the first start, which is the start of the first stroke region RS1, to “7.3” of the first end, which is the end of the first stroke region RS1. The first variable rate, which is a value obtained by dividing the difference “0.4” between the rotation linear motion conversion ratio “7.7” of the first start and the rotation linear motion conversion ratio “7.3” of the first end by the rotation linear motion conversion ratio “7.7” of the first start, is about “5.2%”.

As shown in FIG. 15, in the second stroke region RS2, the rotation linear motion conversion ratio changes from “7.3” of the second start, which is the start of the second stroke region RS2, to “5.6” of the second end, which is the end of the second stroke region RS2. The second variable rate, which is a value obtained by dividing the difference “1.7” between the rotation linear motion conversion ratio “7.3” of the second start and the rotation linear motion conversion ratio “5.6” of the second end by the rotation linear motion conversion ratio “7.3” of the second start, is about “23.3%”.

As described with reference to FIG. 8, in the operation input device 100, the linear motion conversion mechanism 5 is configured such that the second variable rate is higher than the first variable rate. The linear motion conversion mechanism 5 of the operation input device 100 according to the eighth embodiment is also configured such that the second variable rate is higher than the first variable rate. The linear motion conversion mechanism 5 is preferably configured such that in the linear motion conversion ratio in the second stroke region RS2, the movement amount of the piston 4 increases as the rotation angle of the input member 1 increases, and the second variable rate is 20% or more. In the linear motion conversion mechanism 5 of the operation input device 100 according to the eighth embodiment, the second variable rate is about “23.3%”, which satisfies this condition.

### 12. Ninth Embodiment

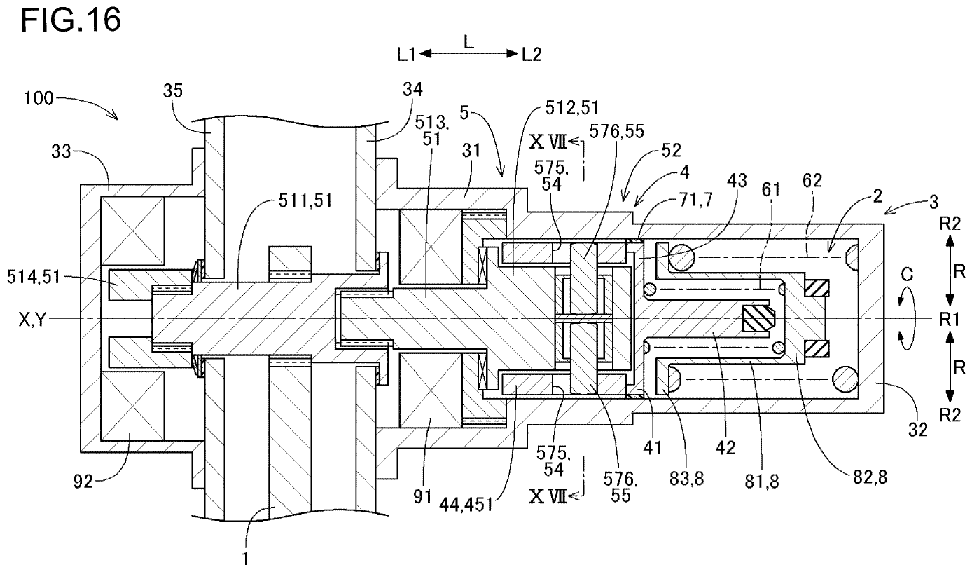

Another configuration example of the reaction force generation mechanism 2 including the linear motion conversion mechanism 5 using the cam mechanism 52 described above as the third embodiment will be exemplified as the ninth embodiment with reference to FIGS. 16 to 19. Hereinafter, differences from the above embodiments (particularly, the first to third embodiments) will be mainly described. Points not specifically described are similar to those in the above embodiments.

The linear motion conversion mechanism 5 includes the transmission member 51, the piston 4, the tubular member 3, the cam mechanism 52, and the guide mechanism 53.

The transmission member 51 is a shaft member to which rotation of the input member 1 is transmitted. The transmission member 51 is formed to extend along the axial direction L. The transmission member 51 is disposed on the reference axis X. The transmission member 51 is supported so as to be rotatable about the reference axis X with respect to the tubular member 3, and rotates integrally with the input member 1. The piston 4 includes an outer arrangement portion 451 disposed on the radial outside R2 with respect to the transmission member 51. The piston 4 is disposed on the reference axis X. The piston 4 is supported movably in the axial direction L with respect to the tubular member 3.

The cam mechanism 52 is configured to convert the rotational motion of the transmission member 51 into the motion of the piston 4 in the axial direction L and transmit the motion. The transmission member 51 and the piston 4 are coupled to each other via the cam mechanism 52. The piston 4 includes the slider 41, the shaft 42, and the flange 43 (radially extending portion).

The guide mechanism 53 is configured to restrict the motion of the piston 4 in the circumferential direction C with respect to the tubular member 3 and allow the motion of the piston 4 in the axial direction L with respect to the tubular member 3. Therefore, the piston 4 and the tubular member 3 are coupled to each other via the guide mechanism 53.

The transmission member 51 includes the first coupling portion 511 coupled to the input member 1, the second coupling portion 512 coupled to the cam mechanism 52, the third coupling portion 513 coupling the first coupling portion 511 and the second coupling portion 512 in the axial direction L, and a fourth coupling portion 514 coupled to an end of the first coupling portion 511 on the axial first side L1. The first coupling portion 511 is disposed so as to penetrate the first side wall 34 and the second side wall 35 in the axial direction L, and rotates integrally with the input member 1. The second coupling portion 512 is disposed away from the first coupling portion 511 on the axial second side L2. The third coupling portion 513 has a cylindrical shape centered on the reference axis X, and is coupled to an end of the first coupling portion 511 on the axial second side L2. The fourth coupling portion 514 has a cylindrical shape centered on the reference axis X and rotates integrally with the first coupling portion 511.

As shown in FIG. 16, in the ninth embodiment, the tubular member 3 includes the first side wall 34 and the second side wall 35. Each of the first side wall 34 and the second side wall 35 is formed to extend along the radial direction R. The first side wall 34 is joined to the peripheral wall 31 from the axial first side L1 so as to close the opening on the axial first side L1 of the peripheral wall 31. The first side wall 34 is disposed on the axial second side L2 with respect to the input member 1. The second side wall 35 is disposed on the axial first side L1 with respect to the input member 1.

The first coupling portion 511 of the transmission member 51 is disposed so as to penetrate the first side wall 34 and the second side wall 35 in the axial direction L. Then, the third coupling portion 513 is coupled to the end of the first coupling portion 511 on the axial second side L2. In the present embodiment, the third coupling portion 513 has a cylindrical shape centered on the reference axis X.

The cover 33 is formed to cover the fourth coupling portion 514 from the axial first side L1 and the radial outside R2. Then, the cover 33 is joined to the second side wall 35 from the axial first side L1.

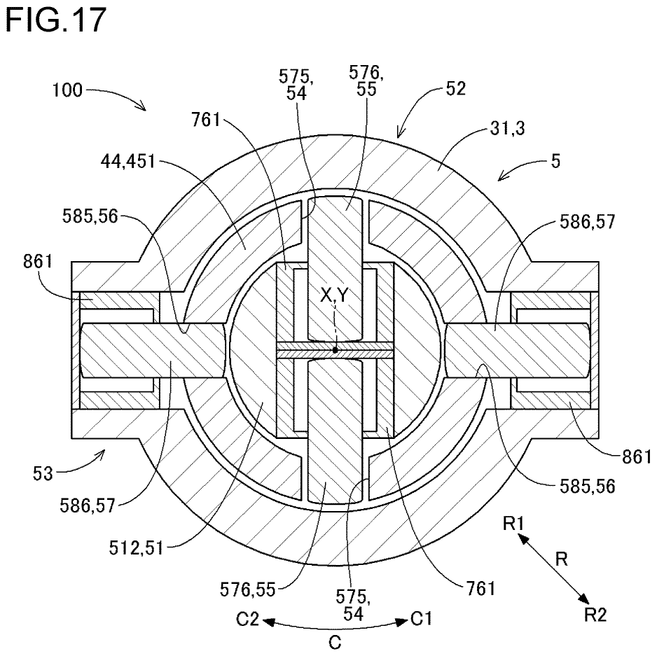

As shown in FIGS. 16 and 17, the outer arrangement portion 451 of the piston 4 includes one path forming portion 44. The path forming portion 44 has a cylindrical shape centered on the reference axis X, and is disposed so as to extend from the slider 41 toward the axial first side L1.

The cam path 54 is a first cam groove 575 formed so as to penetrate the path forming portion 44 in the radial direction R at each of two portions facing each other in the radial direction R in the path forming portion 44. The cam follower member 55 is a first pin 576 that rolls on the inner surfaces of a pair of the first cam grooves 575.

Each of the pair of first pins 576 is inserted into the first cam groove 575 from the radial inside R1. A portion of the first pin 576 on the radial inside R1 of the first cam groove 575 is rotatably held by the first holder 761 so that each of the pair of first pins 576 rotates about an axis of the first pin 576. The pair of first holders 761 is fixed to the second coupling portion 512 of the transmission member 51. In this manner, each of the pair of first pins 576 is configured to roll on the inner surface of the first cam groove 575.

As shown in FIG. 17, the guide path 56 is a first guide groove 585 formed so as to penetrate the path forming portion 44 in the radial direction R at each of two portions facing each other in the radial direction R in the path forming portion 44. The guide follower member 57 is a second pin 586 that rolls on the inner surfaces of a pair of the first guide grooves 585.

Each of the pair of second pins 586 is inserted into the first guide groove 585 from the radial inside R1. Then, a portion of the second pin 586 on the radial inside R1 of the first guide groove 585 is rotatably held by the second holder 861 so that each of the pair of second pins 586 rotates about an axis of the second pin 586. The pair of second holders 861 is fixed to the peripheral wall 31 of the tubular member 3. In this manner, each of the pair of second pins 586 is configured to roll on the inner surface of the first guide groove 585.

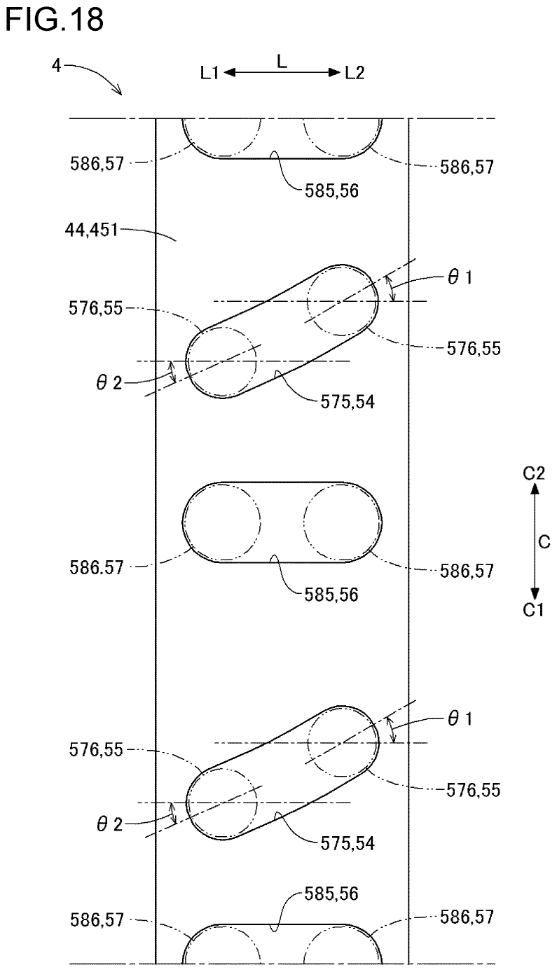

FIG. 18 shows a diagram in which the path forming portion 44 in which the pair of first cam grooves 575 and the pair of first guide grooves 585 are formed is developed on a plane along the circumferential direction C.

As shown in FIG. 18, the pair of first cam grooves 575 is disposed at equal intervals in the circumferential direction C. Each of the pair of first cam grooves 575 is gradually inclined to the axial first side L1 toward the circumferential first side C1.

In a case where the rotational operation force is not input to input member 1, each of the pair of first pins 576 is located at a position closest to the circumferential second side C2 in the first cam groove 575 (hereinafter, referred to as a “reference position”). Then, in a case where the rotational operation force is input to input member 1, each of the pair of first pins 576 is relatively movable to the position (hereinafter, referred to as a “limit position”) closest to the axial first side L1 in the first cam groove 575. Therefore, in a case where the rotational operation force is input to the input member 1 so that the pair of first pins 576 rotates to the circumferential first side C1, the piston 4 moves to the axial second side L2.

Each of the pair of first cam grooves 575 is formed such that an inclination angle with respect to the axial direction L gradually decreases from the reference position toward the limit position. That is, a first angle θ1, which is the inclination angle of the first cam groove 575 with respect to the axial direction L at the reference position, is larger than a second angle θ2, which is an inclination angle of the first cam groove 575 with respect to the axial direction L at the limit position. Therefore, the ratio of a movement amount of the piston 4 in the axial direction L to a movement amount of the first pin 576 in the circumferential direction C at the reference position is smaller than the ratio of the movement amount of the piston 4 in the axial direction L to the movement amount of the first pin 576 in the circumferential direction C at the limit position.

In this manner, the linear motion conversion mechanism 5 according to the ninth embodiment is configured such that the movement amount of the piston 4 in the axial direction L per unit rotation angle of the input member 1 gradually increases as the rotation angle of the input member 1 from the reference angle (rotation angle in a case where the rotational operation force is not input to the input member 1) increases. Such a configuration makes it easy for the driver to have a natural feeling of operation of the operation tool.

The pair of first guide grooves 585 is disposed at equal intervals in the circumferential direction C. Each of the pair of first guide grooves 585 is formed to extend along the axial direction L.

In a case where the rotational operation force is not input to input member 1, each of the pair of second pins 586 is located at a position closest to the axial second side L2 in the first guide groove 585. In a case where the rotational operation force is input to the input member 1, each of the pair of second pins 586 is relatively movable to a position closest to the axial first side L1 in the first guide groove 585. At this time, since the outer diameter of each of the pair of second pins 586 is set to be substantially equal to the dimension of the first guide groove 585 in the circumferential direction C, the relative movement of the pair of second pins 586 in the circumferential direction C is restricted. As a result, the rotation of the piston 4 in the circumferential direction C with respect to the tubular member 3 is restricted.

FIG. 19 is a graph showing an example of the rotation linear motion conversion ratio (=rotation angle/linear movement amount) of the operation input device 100 according to the ninth embodiment. The horizontal axis indicates the pedal stroke, and the vertical axis indicates the rotation linear motion conversion ratio.

As shown in FIG. 19, in the first stroke region RS1, the rotation linear motion conversion ratio is the same value between “7.77” of the first start which is the start of the first stroke region RS1 and “7.77” of the first end which is the end of the first stroke region RS1. Therefore, the first variable rate, which is a value obtained by dividing the difference between the rotation linear motion conversion ratio of the first start and the rotation linear motion conversion ratio of the first end by the rotation linear motion conversion ratio of the first start, is zero.

As shown in FIG. 19, in the second stroke region RS2, the rotation linear motion conversion ratio changes from “7.77” of the second start, which is the start of the second stroke region RS2, to “5.93” of the second end, which is the end of the second stroke region RS2. The second variable rate, which is a value obtained by dividing the difference “1.84” between the rotation linear motion conversion ratio “7.77” of the second start and the rotation linear motion conversion ratio “5.93” of the second end by the rotation linear motion conversion ratio “7.77” of the second start, is about “23.68%”.

As described with reference to FIG. 8, in the operation input device 100, the linear motion conversion mechanism 5 is configured such that the second variable rate is higher than the first variable rate. The linear motion conversion mechanism 5 of the operation input device 100 according to the ninth embodiment is also configured such that the second variable rate is higher than the first variable rate. The linear motion conversion mechanism 5 is preferably configured such that in the linear motion conversion ratio in the second stroke region RS2, the movement amount of the piston 4 increases as the rotation angle of the input member 1 increases, and the second variable rate is 20% or more. In the linear motion conversion mechanism 5 of the operation input device 100 according to the ninth embodiment, the second variable rate is about “23.68%”, which satisfies this condition.

### 13. Summary of Embodiments

Hereinafter, an outline of the operation input device (100) described above will be described.
<1> As one aspect, an operation input device (100) includes
   an input member (1) to which a rotational operation force is input, and
   a reaction force generation mechanism (2) that generates a reaction force against the rotational operation force input to the input member (1), in which
   a direction along a reference axis (X) is defined as an axial direction (L), one side in the axial direction (L) is defined as an axial first side (L1), and another side in the axial direction (L) is defined as an axial second side (L2),
   the reaction force generation mechanism (2) includes
   a tubular member (3) disposed on the reference axis (X),
   a piston (4) accommodated in the tubular member (3),
   a linear motion conversion mechanism (5) that mutually converts rotational motion of the input member (1) and linear motion of the piston (4) along the axial direction (L),
   a first elastic member (61) that biases the piston (4) toward the axial first side (L1), and
   a second elastic member (62) that biases the piston (4) toward the axial first side (L1) and has a biasing force different from a biasing force of the first elastic member (61),
   a region in which the first elastic member (61) is mainly deformed when the piston (4) moves to the axial second side (L2) with respect to the tubular member (3) along the axial direction (L) is defined as a first stroke region (RS1), and a region in which the second elastic member (62) is mainly deformed is defined as a second stroke region (RS2),
   a movement amount of the piston (4) with respect to a rotation angle of the input member (1) is defined as a linear motion conversion ratio of the linear motion conversion mechanism (5),
   a value obtained by dividing a difference between the linear motion conversion ratio of a first start (P1) that is a start of the first stroke region (RS1) and the linear motion conversion ratio of a first end (P2) that is an end of the first stroke region (RS1) by the linear motion conversion ratio of the first start (P1) is set as a first variable rate,
   a value obtained by dividing a difference between the linear motion conversion ratio of a second start (P2) that is a start of the second stroke region (RS2) and the linear motion conversion ratio of a second end (Pf) that is an end of the second stroke region (RS2) by the linear motion conversion ratio of the second start (P2) is defined as a second variable rate, and
   the linear motion conversion mechanism (5) is configured such that the second variable rate is higher than the first variable rate.

In other words, an operation input device includes an input member to which a rotational operation force is input, and a reaction force generation mechanism that generates a reaction force against the rotational operation force input to the input member, in which a direction along a reference axis is defined as an axial direction, one side in the axial direction is defined as an axial first side, and another side in the axial direction is defined as an axial second side, the reaction force generation mechanism includes a tubular member disposed on the reference axis, a piston accommodated in the tubular member, a linear motion conversion mechanism that mutually converts rotational motion of the input member and linear motion of the piston along the axial direction, a first elastic member that biases the piston toward the axial first side, and a second elastic member that biases the piston toward the axial first side and has a biasing force different from a biasing force of the first elastic member, a region in which the first elastic member is mainly deformed when the piston moves to the axial second side with respect to the tubular member along the axial direction is defined as a first stroke region, and a region in which the second elastic member is mainly deformed is defined as a second stroke region, a movement amount of the piston with respect to a rotation angle of the input member is defined as a linear motion conversion ratio of the linear motion conversion mechanism, a value obtained by dividing a difference between the linear motion conversion ratio of a first start that is a start of the first stroke region and the linear motion conversion ratio of a first end that is an end of the first stroke region by the linear motion conversion ratio of the first start is set as a first variable rate, a value obtained by dividing a difference between the linear motion conversion ratio of a second start that is a start of the second stroke region and the linear motion conversion ratio of a second end that is an end of the second stroke region by the linear motion conversion ratio of the second start is defined as a second variable rate, and the linear motion conversion mechanism is configured such that the second variable rate is higher than the first variable rate.

In this configuration, since the first variable rate representing a degree of change in the linear motion conversion ratio in the first stroke region (RS1) is different from the second variable rate representing a degree of change in the linear motion conversion ratio in the second stroke region (RS2), it is possible to make a difference in the reaction force perceived by an operator throughout the stroke region. In a case where the operator applies the rotational operation force to the input member (1), since the reaction force perceived by the operator is different, the operator can easily feel the feeling of operation, such as the stiffness or the reactivity according to the stroke amount. Specifically, in the first stroke region (RS1), since the variable rate of the linear motion conversion ratio is low, the change in reaction force against the stroke is reduced, the operation on the input member (1) is accelerated, and thus, the effect can be felt more quickly. Since the change in reaction force against the stroke becomes large in the second stroke region (RS2), the operator can control the effect while feeling a change in stiffness when applying the rotational operation force to the input member (1). Since the piston (4) is biased toward the axial first side (L1) by the first elastic member (61) and the second elastic member (62), the return operation of the input member (1) to the initial position can also be appropriately performed.

That is, in this configuration, since the first variable rate representing a degree of change in the linear motion conversion ratio in the first stroke region is different from the second variable rate representing a degree of change in the linear motion conversion ratio in the second stroke region, it is possible to make a difference in the reaction force perceived by an operator throughout the stroke region. In a case where the operator applies the rotational operation force to the input member, since the reaction force perceived by the operator is different, the operator can easily feel the feeling of operation, such as the stiffness or the reactivity according to the stroke amount. Specifically, in the first stroke region, since the variable rate of the linear motion conversion ratio is low, the change in reaction force against the stroke is reduced, the operation on the input member is accelerated, and thus, the effect can be felt more quickly. Since the change in reaction force against the stroke becomes large in the second stroke region, the operator can control the effect while feeling a change in stiffness when applying the rotational operation force to the input member. Since the piston is biased toward the axial first side by the first elastic member and the second elastic member, the return operation of the input member to the initial position can also be appropriately performed. Therefore, this configuration makes it easy to provide the operation input device that can easily achieve both further improvement of the feeling of operation and the improvement of the reliability of the return operation of the input member.
<2> The linear motion conversion mechanism (5) of the operation input device (100) is preferably configured such that in the linear motion conversion ratio in the second stroke region (RS2), the movement amount of the piston (4) increases as the rotation angle of the input member (1) increases, and the second variable rate is 20% or more.

In other words, in the operation input device, the linear motion conversion mechanism is configured such that in the linear motion conversion ratio in the second stroke region, the movement amount of the piston increases as the rotation angle of the input member increases, and the second variable rate is 20% or more.

In this configuration, as the rotation angle of the input member (1) increases in the second stroke region (RS2), the reaction force increases, and an operator more easily perceives a certain feeling of operation.
<3> As one aspect, an operation input device (100) includes
   an input member (1) to which a rotational operation force is input, and
   a reaction force generation mechanism (2) that generates a reaction force against the rotational operation force input to the input member (1), in which
   a direction along a reference axis (X) is defined as an axial direction (L), one side in the axial direction (L) is defined as an axial first side (L1), and another side in the axial direction (L) is defined as an axial second side (L2),
   the reaction force generation mechanism (2) includes
   a tubular member (3) disposed on the reference axis (X),
   a piston (4) accommodated in the tubular member (3), and
   a linear motion conversion mechanism (5) that mutually converts rotational motion of the input member (1) and linear motion of the piston (4) along the axial direction (L),
   a first elastic member (61) that biases the piston (4) toward the axial first side (L1), and
   a second elastic member (62) that biases the piston (4) toward the axial first side (L1) and has a biasing force different from a biasing force of the first elastic member (61),
   a direction orthogonal to the reference axis (X) is defined as a radial direction (R), a direction toward the reference axis (X) along the radial direction (R) is defined as a radial inside (R1), and a direction away from the reference axis (X) along the radial direction (R) is defined as a radial outside (R2),
   the reaction force generation mechanism (2) includes
   a friction member (7) disposed at a sliding portion between an outer peripheral surface of the piston (4) and an inner peripheral surface of the tubular member (3), and
   a strained force application mechanism (74) that presses the friction member (7) from the radial inside (R1) toward the radial outside (R2) and applies a strained force to an inner peripheral surface of the tubular member (3), or presses the friction member (7) from the radial outside (R2) toward the radial inside (R1) and applies a strained force to an outer peripheral surface of the piston (4),
   the friction member (7) includes
   a sliding member (73) disposed on a sliding surface between the tubular member (3) and the piston (4), and
   a base material (70) to which the sliding member (73) is bonded on the radial outside (R2) or the radial inside (R1), and
   the strained force application mechanism (74) presses the base material (70) on which the sliding member (73) is disposed on the radial outside (R2) from the radial inside (R1) toward the radial outside (R2), or presses the base material (70) on which the sliding member (73) is disposed on the radial inside (R1) from the radial outside (R2) toward the radial inside (R1).

In other words, an operation input device includes
an input member to which a rotational operation force is input, and
a reaction force generation mechanism that generates a reaction force against the rotational operation force input to the input member, in which
a direction along a reference axis is defined as an axial direction, one side in the axial direction is defined as an axial first side, and another side in the axial direction is defined as an axial second side,
the reaction force generation mechanism includes
a tubular member disposed on the reference axis,
a piston accommodated in the tubular member,
a linear motion conversion mechanism that mutually converts rotational motion of the input member and linear motion of the piston along the axial direction,
a first elastic member that biases the piston toward the axial first side, and
a second elastic member that biases the piston toward the axial first side and has a biasing force different from a biasing force of the first elastic member,
a direction orthogonal to the reference axis is defined as a radial direction, a direction toward the reference axis along the radial direction is defined as a radial inside, and a direction away from the reference axis along the radial direction is defined as a radial outside,
the reaction force generation mechanism includes
a friction member disposed at a sliding portion between an outer peripheral surface of the piston and an inner peripheral surface of the tubular member, and
a strained force application mechanism that presses the friction member from the radial inside toward the radial outside and applies a strained force to an inner peripheral surface of the tubular member, or presses the friction member from the radial outside toward the radial inside and applies a strained force to an outer peripheral surface of the piston,
the friction member includes
a sliding member disposed on a sliding surface between the tubular member and the piston, and
a base material to which the sliding member is bonded on the radial outside or the radial inside, and
the strained force application mechanism presses the base material on which the sliding member is disposed on the radial outside from the radial inside toward the radial outside, or presses the base material on which the sliding member is disposed on the radial inside from the radial outside toward the radial inside.

In this configuration, by applying the strained force to the inner peripheral surface of the tubular member (3) or the outer peripheral surface of the piston (4) by the strained force application mechanism (74), the frictional force of the friction member (7) is increased, and it is easy to apply an appropriate reaction force in response to the input of the rotational operation force to the input member (1) by the operator. Since the biasing force of the first elastic member (61) and the biasing force of the second elastic member (62) are different from each other, it is possible to make a difference in the reaction force perceived by the operator throughout the entire stroke region in a rotational stroke of the input member (1) and a linear stroke of the piston (4). In a case where the operator applies the rotational operation force to the input member (1), since the reaction force perceived by the operator is different, the operator can easily feel the feeling of operation, such as the stiffness or the reactivity according to the stroke amount. Since the piston (4) is biased toward the axial first side (L1) by the first elastic member (61) and the second elastic member (62), the return operation of the input member (1) to the initial position can also be appropriately performed.

That is, in this configuration, by applying the strained force to the inner peripheral surface of the tubular member or the outer peripheral surface of the piston by the strained force application mechanism, the frictional force of the friction member is increased, and it is easy to apply an appropriate reaction force in response to the input of the rotational operation force to the input member by the operator. Since the biasing force of the first elastic member and the biasing force of the second elastic member are different from each other, it is possible to make a difference in the reaction force perceived by the operator throughout the entire stroke region in a rotational stroke of the input member and a linear stroke of the piston. In a case where the operator applies the rotational operation force to the input member, since the reaction force perceived by the operator is different, the operator can easily feel the feeling of operation, such as the stiffness or the reactivity according to the stroke amount. Since the piston is biased toward the axial first side by the first elastic member and the second elastic member, the return operation of the input member to the initial position can also be appropriately performed. Therefore, this configuration makes it easy to provide the operation input device that can easily achieve both further improvement of the feeling of operation and the improvement of the reliability of the return operation of the input member.
<4> In the operation input device (100), the sliding member (73) is preferably a viscoelastic body (71).

In other words, in the operation input device, the sliding member is a viscoelastic body.

In this configuration, the frictional force of the friction member (7) can be increased as the piston (4) moves faster. Therefore, it is easy to enhance the feeling of operation of the operation input device (100).
<5> In the operation input device (100),
   the reaction force generation mechanism (2) includes a strained force adjustment mechanism that allows adjustment of a strained force applied to the friction member (7), and
   the piston (4) includes
   a first member (40a) disposed on the axial first side (L1),
   a second member (40b) disposed on the axial second side (L2), and
   a position adjustment mechanism (400) that adjusts arrangement positions of the first member (40a) and the second member (40b) in the axial direction (L), and
   the strained force application mechanism (74) is configured by an annular elastic body (72) disposed between the first member (40a) and the second member (40b) in the axial direction (L), and
   the strained force adjustment mechanism is configured by the position adjustment mechanism (400).

In other words, in the operation input device,
the reaction force generation mechanism includes a strained force adjustment mechanism that allows adjustment of a strained force applied to the friction member, and
the piston includes
a first member disposed on the axial first side,
a second member disposed on the axial second side, and
a position adjustment mechanism that adjusts arrangement positions of the first member and the second member in the axial direction,
the strained force application mechanism is configured by an annular elastic body disposed between the first member and the second member in the axial direction, and
the strained force adjustment mechanism is configured by the position adjustment mechanism.

An appropriate reaction force may be different depending on a target on which the operation input device (100) is mounted, and the appropriate strained force may also be different depending on each target. In this configuration, by providing the strained force adjustment mechanism, the strained force can be appropriately adjusted in accordance with the target on which the operation input device (100) is mounted.
<6> In the operation input device (100),
   the reaction force generation mechanism (2) includes a strained force amplification mechanism (410) that allows amplification of a strained force applied to the friction member (7) as a linear motion operation force that moves the piston (4) to the axial second side (L2) along the axial direction (L) increases, and
   the piston (4) includes
   a first member (40a) disposed on the axial first side (L1), and
   a second member (40b) disposed on the axial second side (L2) so as to be relatively movable in the axial direction (L) with respect to the first member (40a), and
   the strained force application mechanism (410) is configured by an annular elastic body (72) disposed between the first member (40a) and the second member (40b) in the axial direction (L), and
   the strained force amplification mechanism (410) is configured by the piston (4) that is divided and the annular elastic body (72).

In other words, in the operation input device,
the reaction force generation mechanism includes a strained force amplification mechanism that allows amplification of a strained force applied to the friction member as a linear motion operation force that moves the piston to the axial second side along the axial direction increases, and
the piston includes
a first member disposed on the axial first side, and
a second member disposed on the axial second side so as to be relatively movable in the axial direction with respect to the first member,
the strained force application mechanism is configured by an annular elastic body disposed between the first member and the second member in the axial direction, and
the strained force amplification mechanism is configured by the piston that is divided and the annular elastic body.

In this configuration, as the separation distance (d) between the first member (40a) and the second member (40b) in the axial direction (L) decreases, the annular elastic body (72) bulges in the radial direction (R), and it is thus possible to appropriately increase the strained force to the radial outside (R2). Since the rotational operation force becomes stronger and the strained force becomes stronger as a linear movement force increases, it is possible to give the operator an appropriate feeling of operation.
<7> In the operation input device (100), preferably,
   the piston (4) includes
   a first member (40a) disposed on the axial first side (L1),
   a second member (40b) disposed on the axial second side (L2) so as to be relatively movable in the axial direction (L) with respect to the first member (40a),
   the outer peripheral surface of the first member (40a) includes an outer peripheral inclined surface (410a) inclined to the radial inside (R1) toward the axial second side (L2), and
   the base material (70) includes an inner peripheral inclined surface (70a) inclined to the radial inside (R1) toward the axial second side (L2) on the radial inside (R1),
   the base material (70) is disposed between the first member (40a) and the second member (40b) in the axial direction (L) and between the outer peripheral inclined surface (410a) and an inner peripheral surface of the tubular member (3) such that the inner peripheral inclined surface (70a) is engaged with the outer peripheral inclined surface (410a), and
   the strained force application mechanism (74) applies a strained force to the inner peripheral surface of the tubular member (3) by changing a position in the axial direction (L) at which the outer peripheral inclined surface (410a) and the inner peripheral inclined surface (70a) are in contact with each other along with movement of the piston (4) to the axial second side (L2).

In other words, in the operation input device,
the piston includes
a first member disposed on the axial first side,
a second member disposed on the axial second side so as to be relatively movable in the axial direction with respect to the first member,
the outer peripheral surface of the first member includes an outer peripheral inclined surface inclined to the radial inside toward the axial second side, and
the base material includes an inner peripheral inclined surface inclined to the radial inside toward the axial second side on the radial inside,
the base material is disposed between the first member and the second member in the axial direction and between the outer peripheral inclined surface and an inner peripheral surface of the tubular member such that the inner peripheral inclined surface is engaged with the outer peripheral inclined surface, and
the strained force application mechanism applies a strained force to the inner peripheral surface of the tubular member by changing a position in the axial direction at which the outer peripheral inclined surface and the inner peripheral inclined surface are in contact with each other along with movement of the piston to the axial second side.

In this configuration, in a case where the piston (4) moves to the axial second side (L2), the position of the base material (70) in the radial direction (R) can be moved to the radial outside (R2) as the separation distance (d) between the first member (40a) and the second member (40b) in the axial direction (L) decreases. That is, as the linear motion operation force that moves the piston (4) to the axial second side (L2) increases, the strained force applied to the friction member (7) via the base material (70) can be increased. Since the rotational operation force becomes stronger and the strained force becomes stronger as a linear movement force increases, it is possible to give the operator an appropriate feeling of operation.
<8> As one aspect, an operation input device (100) includes
   an input member (1) to which a rotational operation force is input, and
   a reaction force generation mechanism (2) that generates a reaction force against the rotational operation force, in which
   a direction along a reference axis (X) is defined as an axial direction (L), one side in the axial direction (L) is defined as an axial first side (L1), and another side in the axial direction (L) is defined as an axial second side (L2),
   the reaction force generation mechanism (2) includes
   a tubular member (3) disposed on the reference axis (X),
   a piston (4) accommodated in the tubular member (3),
   a linear motion conversion mechanism (5) configured to mutually convert rotational motion of the input member (1) and linear motion of the piston (4) along the axial direction (L),
   an elastic member (6) that biases the piston (4) toward the axial first side (L1), and
   a friction member (7) disposed at a sliding portion between an outer peripheral surface of the piston (4) and an inner peripheral surface of the tubular member (3), and
   the friction member (7) is configured to have a larger frictional force in a case where the piston (4) moves to the axial second side (L2) than in a case where the piston (4) moves to the axial first side (L1).

In other words, an operation input device includes an input member to which a rotational operation force is input, and a reaction force generation mechanism that generates a reaction force against the rotational operation force input to the input member, in which a direction along a reference axis is defined as an axial direction, one side in the axial direction is defined as an axial first side, and another side in the axial direction is defined as an axial second side, the reaction force generation mechanism includes
a tubular member disposed on the reference axis, a piston accommodated in the tubular member, a linear motion conversion mechanism configured to mutually convert rotational motion of the input member and linear motion of the piston along the axial direction, an elastic member that biases the piston toward the axial first side, and a friction member disposed at a sliding portion between an outer peripheral surface of the piston and an inner peripheral surface of the tubular member, and the friction member is configured to have a larger frictional force in a case where the piston moves to the axial second side than in a case where the piston moves to the axial first side.

In this configuration, in a case where the rotational operation force is input to the input member (1) so that the piston (4) moves to the axial second side (L2), a relatively large reaction force with respect to the rotational operation force input to the input member (1) can be generated by the biasing force to the axial first side (L1) by the elastic member (6) and the relatively large frictional force of the friction member (7). On the other hand, in a case where the input of the rotational operation force to the input member (1) is released, the piston (4) can be relatively easily moved to the axial first side (L1) by the biasing force to the axial first side (L1) by the elastic member (6) and the relatively small frictional force of the friction member (7). Thus, it is possible to appropriately perform a return operation to the initial position of the input member (1) in a case of moving the piston (4) to the axial first side (L1) by a biasing force of the elastic member (6) while largely securing the reaction force by the reaction force generation mechanism (2) in a case of moving the piston (4) to the axial second side (L2). Therefore, it is easy to achieve both the improvement of the feeling of operation of the operation input device (100) and the improvement of the reliability of the return operation of the input member (1).

That is, in this configuration, in a case where the rotational operation force is input to the input member so that the piston moves to the axial second side, a relatively large reaction force with respect to the rotational operation force input to the input member can be generated by the biasing force to the axial first side by the elastic member and the relatively large frictional force of the friction member. On the other hand, in a case where the input of the rotational operation force to the input member is released, the piston can be relatively easily moved to the axial first side by the biasing force to the axial first side by the elastic member and the relatively small frictional force of the friction member. Thus, it is possible to appropriately perform a return operation to the initial position of the input member in a case of moving the piston to the axial first side by a biasing force of the elastic member while largely securing the reaction force by the reaction force generation mechanism in a case of moving the piston to the axial second side. Therefore, it is easy to achieve both the improvement of the feeling of operation of the operation input device and the improvement of the reliability of the return operation of the input member.
<9> In the operation input device (100), preferably, the friction member (7) has a sliding surface with the tubular member (3), and the viscoelastic body (71) is disposed on the sliding surface.

In other words, in the operation input device, the friction member has a sliding surface with the tubular member, and a viscoelastic body is disposed on the sliding surface.

In this configuration, the frictional force of the friction member (7) can be increased as the piston (4) moves faster. Therefore, it is easy to enhance the feeling of operation of the operation input device (100).
<10> In the operation input device (100),
   the friction member (7) is attached to the outer peripheral surface of the piston (4), and
   a direction orthogonal to the reference axis (X) is defined as a radial direction (R), and a direction away from the reference axis (X) along the radial direction (R) is defined as a radial outside (R2),
   the outer peripheral surface of the piston (4) includes an outer peripheral inclined surface (4a) inclined to the radial outside (R2) toward the axial first side (L1),
   the friction member (7) includes an inner peripheral inclined surface (7a) that is inclined to the radial outside (R2) toward the axial first side (L1) and is in contact with the outer peripheral inclined surface (4a), and
   the reaction force generation mechanism (2) applies a strained force to the inner peripheral surface of the tubular member (3) by changing a position in the axial direction (L) at which the outer peripheral inclined surface (4a) and the inner peripheral inclined surface (7a) are in contact with each other along with movement of the piston (4) toward the axial second side (L2).

In other words, in the operation input device,
the friction member is attached to the outer peripheral surface of the piston, and
a direction orthogonal to the reference axis is defined as a radial direction, and a direction away from the reference axis along the radial direction is defined as a radial outside,
the outer peripheral surface of the piston includes an outer peripheral inclined surface inclined to the radial outside toward the axial first side,
the friction member includes an inner peripheral inclined surface that is inclined to the radial outside toward the axial first side and is in contact with the outer peripheral inclined surface, and
the reaction force generation mechanism applies a strained force to the inner peripheral surface of the tubular member by changing a position in the axial direction at which the outer peripheral inclined surface and the inner peripheral inclined surface are in contact with each other along with movement of the piston toward the axial second side.

In this configuration, in a case where the piston (4) moves to the axial second side (L2), the friction member (7) is easily moved to the side where the distance in the radial direction (R) between the outer peripheral surface of the piston (4) and the inner peripheral surface of the tubular member (3) is reduced. As a result, a strained force can be appropriately applied to the tubular member (3).
<11> In the operation input device (100), preferably, the friction member (7) is an annular elastic body (72), and is disposed on the reference axis (X) in a state of being attached to the outer peripheral surface of the piston (4).

In other words, in the operation input device, the friction member is an annular elastic body, and is disposed on the reference axis in a state of being attached to the outer peripheral surface of the piston.

In this configuration, the friction member (7) can be stably attached to the outer peripheral surface of the piston (4). Furthermore, in a case where the piston (4) moves to the axial second side (L2), the friction member (7) is more easily moved to the side where the width in the radial direction (R) between the outer peripheral surface of the piston (4) and the inner peripheral surface of the tubular member (3) is reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An operation input device comprising:
an input member to which a rotational operation force is input; and
a reaction force generation mechanism that generates a reaction force against the rotational operation force input to the input member, wherein
a direction along a reference axis is defined as an axial direction, one side in the axial direction is defined as an axial first side, and another side in the axial direction is defined as an axial second side,
the reaction force generation mechanism includes
a tubular member disposed on the reference axis,
a piston accommodated in the tubular member,
a linear motion conversion mechanism that mutually converts rotational motion of the input member and linear motion of the piston along the axial direction,
a first elastic member that biases the piston toward the axial first side, and
a second elastic member that biases the piston toward the axial first side and has a biasing force different from a biasing force of the first elastic member,
a region in which the first elastic member is mainly deformed when the piston moves to the axial second side with respect to the tubular member along the axial direction is defined as a first stroke region, and a region in which the second elastic member is mainly deformed is defined as a second stroke region,
a movement amount of the piston with respect to a rotation angle of the input member is defined as a linear motion conversion ratio of the linear motion conversion mechanism,
a value obtained by dividing a difference between the linear motion conversion ratio of a first start that is a start of the first stroke region and the linear motion conversion ratio of a first end that is an end of the first stroke region by the linear motion conversion ratio of the first start is set as a first variable rate,
a value obtained by dividing a difference between the linear motion conversion ratio of a second start that is a start of the second stroke region and the linear motion conversion ratio of a second end that is an end of the second stroke region by the linear motion conversion ratio of the second start is defined as a second variable rate, and
the linear motion conversion mechanism is configured such that the second variable rate is higher than the first variable rate.

2. The operation input device according to claim 1, wherein
the linear motion conversion mechanism is configured such that
in the linear motion conversion ratio in the second stroke region, the movement amount of the piston increases as the rotation angle of the input member increases, and
the second variable rate is 20% or more.

3. An operation input device comprising:
an input member to which a rotational operation force is input; and
a reaction force generation mechanism that generates a reaction force against the rotational operation force input to the input member, wherein
a direction along a reference axis is defined as an axial direction, one side in the axial direction is defined as an axial first side, and another side in the axial direction is defined as an axial second side,
the reaction force generation mechanism includes
a tubular member disposed on the reference axis,
a piston accommodated in the tubular member, and
a linear motion conversion mechanism that mutually converts rotational motion of the input member and linear motion of the piston along the axial direction,
a first elastic member that biases the piston toward the axial first side, and
a second elastic member that biases the piston toward the axial first side and has a biasing force different from a biasing force of the first elastic member,
a direction orthogonal to the reference axis is defined as a radial direction, a direction toward the reference axis along the radial direction is defined as a radial inside, and a direction away from the reference axis along the radial direction is defined as a radial outside,
the reaction force generation mechanism includes
a friction member disposed at a sliding portion between an outer peripheral surface of the piston and an inner peripheral surface of the tubular member, and
a strained force application mechanism that presses the friction member from the radial inside toward the radial outside and applies a strained force to an inner peripheral surface of the tubular member, or presses the friction member from the radial outside toward the radial inside and applies a strained force to an outer peripheral surface of the piston,
the friction member includes
a sliding member disposed on a sliding surface between the tubular member and the piston, and
a base material to which the sliding member is bonded on the radial outside or the radial inside, and
the strained force application mechanism presses the base material on which the sliding member is disposed on the radial outside from the radial inside toward the radial outside, or presses the base material on which the sliding member is disposed on the radial inside from the radial outside toward the radial inside.

4. The operation input device according to claim 3, wherein the sliding member is a viscoelastic body.

5. The operation input device according to claim 3, wherein
the reaction force generation mechanism includes a strained force adjustment mechanism that allows adjustment of a strained force applied to the friction member, and
the piston includes
a first member disposed on the axial first side,
a second member disposed on the axial second side, and
a position adjustment mechanism that adjusts arrangement positions of the first member and the second member in the axial direction,
the strained force application mechanism is configured by an annular elastic body disposed between the first member and the second member in the axial direction, and
the strained force adjustment mechanism is configured by the position adjustment mechanism.

6. The operation input device according to claim 3, wherein
the reaction force generation mechanism includes a strained force amplification mechanism that allows amplification of a strained force applied to the friction member as a linear motion operation force that moves the piston to the axial second side along the axial direction increases, and
the piston includes
a first member disposed on the axial first side, and
a second member disposed on the axial second side so as to be relatively movable in the axial direction with respect to the first member,
the strained force application mechanism is configured by an annular elastic body disposed between the first member and the second member in the axial direction, and
the strained force amplification mechanism is configured by the piston that is divided and the annular elastic body.

7. The operation input device according to claim 3, wherein
the piston includes
a first member disposed on the axial first side,
a second member disposed on the axial second side so as to be relatively movable in the axial direction with respect to the first member,
the outer peripheral surface of the first member includes an outer peripheral inclined surface inclined to the radial inside toward the axial second side, and
the base material includes an inner peripheral inclined surface inclined to the radial inside toward the axial second side on the radial inside,
the base material is disposed between the first member and the second member in the axial direction and between the outer peripheral inclined surface and an inner peripheral surface of the tubular member such that the inner peripheral inclined surface is engaged with the outer peripheral inclined surface, and
the strained force application mechanism applies a strained force to the inner peripheral surface of the tubular member by changing a position in the axial direction at which the outer peripheral inclined surface and the inner peripheral inclined surface are in contact with each other along with movement of the piston to the axial second side.

8. The operation input device according to claim 4, wherein
the reaction force generation mechanism includes a strained force adjustment mechanism that allows adjustment of a strained force applied to the friction member, and
the piston includes
a first member disposed on the axial first side,
a second member disposed on the axial second side, and
a position adjustment mechanism that adjusts arrangement positions of the first member and the second member in the axial direction,
the strained force application mechanism is configured by an annular elastic body disposed between the first member and the second member in the axial direction, and
the strained force adjustment mechanism is configured by the position adjustment mechanism.

9. The operation input device according to claim 4, wherein
the reaction force generation mechanism includes a strained force amplification mechanism that allows amplification of a strained force applied to the friction member as a linear motion operation force that moves the piston to the axial second side along the axial direction increases, and
the piston includes
a first member disposed on the axial first side, and
a second member disposed on the axial second side so as to be relatively movable in the axial direction with respect to the first member,
the strained force application mechanism is configured by an annular elastic body disposed between the first member and the second member in the axial direction, and
the strained force amplification mechanism is configured by the piston that is divided and the annular elastic body.

10. The operation input device according to claim 4, wherein
the piston includes
a first member disposed on the axial first side,
a second member disposed on the axial second side so as to be relatively movable in the axial direction with respect to the first member,
the outer peripheral surface of the first member includes an outer peripheral inclined surface inclined to the radial inside toward the axial second side, and
the base material includes an inner peripheral inclined surface inclined to the radial inside toward the axial second side on the radial inside,
the base material is disposed between the first member and the second member in the axial direction and between the outer peripheral inclined surface and an inner peripheral surface of the tubular member such that the inner peripheral inclined surface is engaged with the outer peripheral inclined surface, and
the strained force application mechanism applies a strained force to the inner peripheral surface of the tubular member by changing a position in the axial direction at which the outer peripheral inclined surface and the inner peripheral inclined surface are in contact with each other along with movement of the piston to the axial second side.

11. An operation input device comprising:
an input member to which a rotational operation force is input; and
a reaction force generation mechanism that generates a reaction force against the rotational operation force input to the input member, wherein
a direction along a reference axis is defined as an axial direction, one side in the axial direction is defined as an axial first side, and another side in the axial direction is defined as an axial second side,
the reaction force generation mechanism includes
a tubular member disposed on the reference axis,
a piston accommodated in the tubular member,
a linear motion conversion mechanism configured to mutually convert rotational motion of the input member and linear motion of the piston along the axial direction,
an elastic member that biases the piston toward the axial first side, and
a friction member disposed at a sliding portion between an outer peripheral surface of the piston and an inner peripheral surface of the tubular member, and
the friction member is configured to have a larger frictional force in a case where the piston moves to the axial second side than in a case where the piston moves to the axial first side.

12. The operation input device according to claim 11, wherein the friction member has a sliding surface with the tubular member, and a viscoelastic body is disposed on the sliding surface.

13. The operation input device according to claim 11, wherein
the friction member is attached to the outer peripheral surface of the piston, and
a direction orthogonal to the reference axis is defined as a radial direction, and a direction away from the reference axis along the radial direction is defined as a radial outside,
the outer peripheral surface of the piston includes an outer peripheral inclined surface inclined to the radial outside toward the axial first side,
the friction member includes an inner peripheral inclined surface that is inclined to the radial outside toward the axial first side and is in contact with the outer peripheral inclined surface, and
the reaction force generation mechanism applies a strained force to the inner peripheral surface of the tubular member by changing a position in the axial direction at which the outer peripheral inclined surface and the inner peripheral inclined surface are in contact with each other along with movement of the piston toward the axial second side.

14. The operation input device according to claim 13, wherein the friction member is an annular elastic body, and is disposed on the reference axis in a state of being attached to the outer peripheral surface of the piston.

15. The operation input device according to claim 12, wherein
the friction member is attached to the outer peripheral surface of the piston, and
a direction orthogonal to the reference axis is defined as a radial direction, and a direction away from the reference axis along the radial direction is defined as a radial outside,
the outer peripheral surface of the piston includes an outer peripheral inclined surface inclined to the radial outside toward the axial first side,
the friction member includes an inner peripheral inclined surface that is inclined to the radial outside toward the axial first side and is in contact with the outer peripheral inclined surface, and
the reaction force generation mechanism applies a strained force to the inner peripheral surface of the tubular member by changing a position in the axial direction at which the outer peripheral inclined surface and the inner peripheral inclined surface are in contact with each other along with movement of the piston toward the axial second side.

16. The operation input device according to claim 15, wherein the friction member is an annular elastic body, and is disposed on the reference axis in a state of being attached to the outer peripheral surface of the piston.
